(19) United States
(12) Patent Application Publication
(10) Pub. No.: US 2026/0357519 A1
(43) Pub. Date: Nov. 12, 2026

(54) PACKAGING WITH RECYCLED PULP COMPOSITIONS

(71) Applicant: THE PROCTER & GAMBLE COMPANY, Cincinnati, OH (US)

(72) Inventors: Paul Thomas WEISMAN, Cincinnati, OH (US); Norman Scott BROYLES, Fairfield Township, OH (US); Xiao JIANG, West Chester, OH (US); Anthony Frederick CAPPEL, Cincinnati, OH (US)

(21) Appl. No.: 19/667,726

(22) Filed: May 5, 2026

Related U.S. Application Data
(60) Provisional application No. 63/800,060, filed on May 5, 2025.

(51) Int. Cl. D21H 11/00; B65D 85/00; D21H 17/04; D21H 17/06; D21H 17/10; D21H 17/11

(52) U.S. Cl. CPC D21H 11/00; B65D 85/00; D21H 17/04; D21H 17/06; D21H 17/10; D21H 17/11

(57) ABSTRACT

A package of one or more absorbent articles, the package comprising a package material, wherein the package material comprises at least one of the following:
a. less than about 100 μg/kg of glyphosphate;
b. less than 150 μg/kg of isononylphenol(mono, di, tri, and tetra)exthoxylate;
c. less than 150 μg/kg of Bisphenol-A;
d. less than 25 ng/kg of 1,2,3,4,6,7,8-HpCDD;
e. less than 250 ng/kg of OCDD;
f. less than 5 ng/kg of OCDF;
g. less than 4 ng/kg of PCB 81;
h. less than 350 ng/kg of PCB 105;
i. less than 50 ng/kg of PCB 118;
j. less than 5,000 μg/kg of di-2ethylhexylphthalate;
k. less than 5,000 μg/kg of di-isononylphthalate;
l. less than 10 μg/kg of fluoranthene; and
m. less than 10 μg/kg of phenanthene;
as measured according to the Trace Chemicals Test Method.

### FIELD OF THE INVENTION

The present invention generally relates to packages and packaging material comprising pulp compositions that comprise high purity post-consumer recycled pulp.

### BACKGROUND OF THE INVENTION

In the world today, hundreds of millions of tons of pulp are utilized on an annual basis. The pulps are generally produced from renewable resources. However, the utilization of virgin pulp may deplete natural resources and be a negative on energy, water, land use, etc., and increase production of greenhouse gases (GHG), primarily CO₂, in the atmosphere.

Polysaccharides in fiber form are the basis of most pulps and include wood, cotton, rayon, etc. The use of recycled pulp has emerged as one solution to mitigate the issues associated with the end-of-life of virgin polysaccharides. Recovering and re-using polysaccharides diverts waste from landfills and reduces the demand for virgin materials.

The pulps may be used to produce various forms of paper, cardboards, etc. The pulp may be reclaimed as one of many forms and recycled into one of many forms including paper, cardboards, etc.

Today, in the US, the majority of reclaimed materials destined for recycling, including paper, cardboard, etc., are mixed into a single stream which is collected and processed by a material recovery facility (MRF). At the MRF, materials are sorted, washed, and packaged (e.g., in bales) for resale. Pulp-based materials can be sorted into individual materials.

However, the utilization of reclaimed pulp in recycling is currently limited due to contamination, which renders these less valuable compared to virgin pulp. A key enabler to increase the recycle rates and lowering the CO₂ emissions is to reduce the contamination of recycled pulp to a level allowing broader utilization across more end markets, especially those involving demanding applications. Contamination potentially impacts macroscopic end-use performance such as reduction in mechanical properties such as strength (i.e., tensile, burst, tear, etc.), elongation, absorbency, and impact and increased malodor and non-optimal color.

While contamination is problematic for all end market applications, demanding applications such as foods, hygiene, medical, etc., have even stricter requirements, especially on certain chemical contaminants or trace chemicals. The relevant chemical contaminants or trace chemicals may be grouped into various chemical classes depending on the chemical structure of the contaminants or trace chemicals. Non-limiting examples of these chemical classes of contaminants are PFAs, heavy metals, pesticides, dioxins, furans, polychlorinated biphenyls (PCBs), phthalates, polycyclic aromatic hydrocarbons (PAHs), organotins, bisphenols, isothiazolins, glyphosphate, alkyl phenols, alkylphenol ethoxylates, aromatic amines, and flame retardants. In addition, the target levels of these contaminants or trace chemicals can be extremely low. For instance, the target levels may be on the order of parts per million (ppm), parts per billion (ppb), and parts per trillion (pptr), wherein the initial contaminated material may contain levels 1,000 times the targeted levels. Net, a 1,000× reduction in chemical contamination is often required.

While the recycling of pulp through various cleaning processes is known, there remains a need for recycled pulp compositions, and compositions comprising recycled pulp compositions, that have minimum numbers and levels of contaminants, and that also have the necessary mechanical integrity or performance level of the pulp fibers that allow them to be used in various ways, including in packaging and/or as a component of a package or package material.

### SUMMARY OF THE INVENTION

A package of one or more absorbent articles, the package comprising a package material, wherein the package material comprises from about 30 wt % to about 100 wt % post-consumer recycled pulp fiber;
wherein the package comprises a plurality of panels, wherein one of the panels is a consumer-facing panel;
wherein the package is sealed such that the one or more absorbent articles are enclosed therein; and:
wherein the package material comprises at least one of the following:
   a. less than about 100 μg/kg of glyphosphate;
   b. less than 150 μg/kg of isononylphenol(mono, di, tri, and tetra)exthoxylate;
   c. less than 150 μg/kg of Bisphenol-A;
   d. less than 25 ng/kg of 1,2,3,4,6,7,8-HpCDD;
   e. less than 250 ng/kg of OCDD;
   f. less than 5 ng/kg of OCDF;
   g. less than 4 ng/kg of PCB 81;
   h. less than 350 ng/kg of PCB 105;
   i. less than 50 ng/kg of PCB 118;
   j. less than 5,000 μg/kg of di-2ethylhexylphthalate;
   k. less than 5,000 μg/kg of di-isononylphthalate;
   l. less than 10 μg/kg of fluoranthene; and
   m. less than 10 μg/kg of phenanthene;
as measured according to the Trace Chemicals Test Method.

### BRIEF DESCRIPTION OF THE DRAWINGS

FIG. 1 is a schematic representation of a package in accordance with the present disclosure in an open state.

FIG. 2 is a schematic representation of the package of FIG. 1 in a closed state.

FIG. 3 is a schematic representation showing a package in accordance with the present disclosure constructed via a flow wrap process.

### Pulp Compositions

The pulp compositions of the present invention comprise recycled pulp produced from reclaimed pulp. The difference between recycled and reclaimed pulp is subtle. A reclaimed pulp is a non-virgin pulp that has been collected for potential recycling into a valuable end market. Recycled pulp is produced from the reclaimed pulp after it has been rendered acceptable for use in the end market. In cases wherein the reclaimed pulp can be used as-is in an acceptable end market, then the terms are interchangeable. While use of recycled pulp is known, the present inventive compositions may comprise high amounts of recycled pulp fiber, along with both a low number of contaminants and also low amounts of said contaminants when present. Detailed herein are the types of materials that may have numerous and high levels of contaminants and methods of purifying such materials. The purer materials may then make up a percentage, up to 100% in some embodiments, of the inventive compositions. In some embodiments, the purer inventive materials comprise post-consumer recycled pulp fiber; in other embodiments they comprise post-industrial recycled pulp fiber and in still other embodiments, the purer materials may be a combination of post-consumer and post-industrial recycled pulp fiber.

Furthermore, the pulp compositions may be incorporated into various consumer products and package materials. Such inventions, for example, inventive sanitary tissue products and inventive packages, may contain low numbers and low levels of contaminants while still exhibiting consumer-expected tactile feel and overall high performance.

The inventive package or packaging material of the present invention may be characterized by the low number of contaminants present, or it may be characterized by the low amount of a particular contaminant if it is present. The inventive package or packaging material may also be characterized by its performance in various fiber-based tests, such as basis weight, recyclable percentage, and seal tensile strength.

### DETAILED DESCRIPTION OF THE INVENTION

### I. Definitions

As used herein, the term “pulp” refers to a fibrous composition comprising polysaccharides and may include materials originating from wood, cotton, rayon, etc. Wood pulp refers to pulp originating from a wood source.

As used herein, the term “pulp fiber” refers to the individual fibers that make-up the actual pulp. These fibers may be characterized by a range of geometric parameters including various diameters, lengths, and degree of entanglements and various polysaccharide chemistries.

As used herein, the term “paper” refers to a consolidation of pulp into a flat and relatively consistent material. The paper may contain additional additives such as binders and pigments. Paper may be further processed into other forms. Paper is typically sourced from wood pulp but cotton pulp papers are also known.

“Fiber” and/or “Filament” as used herein means an elongate particulate having an apparent length greatly exceeding its apparent width, i.e., a length to diameter ratio of at least about 10. For purposes of the present invention, a “fiber” is an elongate particulate as described above that exhibits a length of less than 5.08 cm (2 in.) and a “filament” is an elongate particulate as described above that exhibits a length of greater than or equal to 5.08 cm (2 in.).

Fibers are typically considered discontinuous in nature. Non-limiting examples of fibers include wood pulp fibers and synthetic staple fibers such as polyester fibers.

In the present invention, “fiber” refers to papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. Nos. 4,300,981 and 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking.

In addition to the various wood pulp fibers, other fibers such as cotton linters, rayon, lyocell, trichomes, seed hairs, and bagasse can be used in this invention.

Other sources of cellulose in the form of fibers or capable of being spun into fibers include grasses and grain sources.

“Furnish” is an aqueous suspension of cellulose fibers that is used to make paper.

“Cellulosic pulp fiber furnish” is the mixture of fibers and other materials that are blended together in a water suspension to make paper or board.

“Dry fibrous structure” as used herein means that the fibrous structure exhibits a moisture content of less than 20% and/or less than 15% and/or less than 10% and/or less than 7% and/or less than 5% and/or less than 3% and/or less than 1% to 0% and or to greater than 0% by weight of the dry fibrous structure. In one example, the dry fibrous structure of the present invention exhibits a moisture (water) content of from about 0.0001% to about 20% and/or from about 0.001% to about 15% and/or from about 0.001% to about 12% and/or from about 0.001% to about 10% and/or from about 0.001% to about 7% and/or from about 0.001% to about 5%, by weight of the dry fibrous structure.

As used herein, the term “Fibrous structure” refers to a structure that comprises one or more fibrous filaments and/or fibers. In one example, a fibrous structure according to the present invention means an orderly arrangement of filaments and/or fibers within a structure in order to perform a function. Non-limiting examples of fibrous structures of the present invention include paper, and absorbent pads (for example for diapers or feminine hygiene products).

As used herein, the term “virgin pulp” refers to pulp that has not been used to produce a material for a targeted end application. For example, virgin wood pulp is pulp that is produced from wood-based sources and has not been used for the intended purpose previously.

As used herein, the term “reclaimed pulp” refers to non-virgin pulp that has been collected for potential use in an end market. For example, reclaimed wood pulp is pulp that was originally virgin wood pulp but has already been used for an intended purpose such as paper in a 1^{st}, 2^{nd}, 3^{rd}, etc., life.

As used herein, the term “recycled pulp” refers to reclaimed pulp that has been converted into a usable material with established end markets such as packaging. The recycled pulp may be purer than the reclaimed pulp fiber or may be identical except possibly in form. For example, recycled wood pulp is pulp that was reclaimed pulp and then rendered usable in the intended end market. Expanding further, recycled paper is sourced from reclaimed paper that is rendered acceptable for use as paper.

As used herein, the term “recycled pulp composition” refers to recycled pulp that may or may not contain virgin pulp or different types of recycled pulps at different concentrations.

As used herein, “pre-consumer” reclaimed pulp follows the ISO 5270 definition, that is, a descriptive term covering material diverted during a manufacturing process. This term excludes re-utilized material, such as rework, regrind or scrap that has been generated in a given process and is capable of being reclaimed within that same process. The term “post-industrial material” is sometimes used synonymously.

As used herein, “post-consumer” reclaimed pulp follows the ISO 5270 definition, that is, a descriptive term covering material, generated by the end-users of packages/products, that has fulfilled its intended purpose or can no longer be used (including material returned from within the distribution chain). The term “post-use” is sometimes used synonymously.

As used herein, the term “1^{st} Life” refers to the first market use of a virgin material.

As used herein, the term “contaminant” refers to any undesirable material contained on or within the pulp. The term “chemical contaminant” refers to any undesirable chemical species on the surface of the pulp or within the bulk of the pulp and comprises the molecular or elemental composition of the contaminant. The terms may be used interchangeably depending upon the intent. As used herein, the term “contamination” refers to the sum of all contaminants and the term “chemical contamination” refers to the sum of all chemical contaminants. The chemical contaminants are grouped in classes, which include chemical contaminants that have similar chemical structure. For example, As, Hg, and Cr are non-limiting chemical contaminants in the “heavy metals” classification. Each contaminant may have different chemical attributes, such as solubility and diffusivity in the pulp, and target levels depending upon concentration and end use market. The term “contaminant” may be used interchangeably herein with the term “trace chemical”, meaning a small amount of an undesirable material on or within a pulp fiber material.

As used herein, the term “surface contaminant” refers to a contaminant that is on the surface of the pulp fiber. Similarly, the term “surface chemical contaminant” refers to the molecular or elemental composition of the surface contaminant. The surface contaminant may be attached to the surface of the pulp fiber either loosely through physical attraction forces, or more strongly through polar or other forces. In general, a surface contaminant will have less than about 80% of its surface area embedded in the pulp fiber.

As used herein, the term “bulk contaminant” refers to a contaminant that is in the bulk of the pulp fiber. Similarly, the term “bulk chemical contaminant” refers to the molecular or elemental composition of the bulk contaminant. As used herein, a bulk contaminant will have more than about 95% of its surface area embedded in the pulp fiber.

As used herein, the term “surface contamination” and “surface chemical contamination” refers to the sum of all surface contaminants and all surface chemical contaminants, respectively.

As used herein, the term “bulk contamination” and “bulk chemical contamination” refers to the sum of all bulk contaminants and all bulk chemical contaminants, respectively.

As used herein, the term “total contamination” refers to the sum of the surface contamination and bulk contamination and the sum of all the surface chemical contamination and bulk chemical contamination, respectively.

As used herein, the term “permeable contaminant” refers to a chemical contaminant that is both soluble and diffusible in the pulp fiber.

As used herein, the term “impermeable contaminant” refers to a chemical contaminant that is either insoluble or non-diffusible or both in the pulp fiber.

As used herein, the term “permeable contamination” is the sum of all permeable contaminants and the term “impermeable contamination” is the sum of all impermeable contaminants. The sum of all permeable and impermeable contamination is the “chemical contamination” if described in molecular or elemental terms or just simply “the contamination” if described in general terms.

As used herein, the term “intentional contaminant” refers to a contaminant that is intentionally added by the supply chain for a specific purpose to benefit the producer, retailer, or consumer, but may not be desired in the recycled pulp fiber. Examples include print, adhesives for labels, pigments (such as TiO₂), process additives (such as antioxidant (AO)), etc., that are necessary for marketing, branding, processability, and/or end use performance. As used herein, the term “intentional chemical contaminant” refers to an intentional contaminant described by its chemical composition. As used herein, the term “intentional contamination” refers to the sum of all intentional contaminants and the term “intentional chemical contamination” refers to the intentional contamination described by its chemical composition.

As used herein, the term “unintentional contaminant” refers to any contaminant not intentionally added. Examples include dirt and cross-contamination that is not intentionally added by the producer, retailer, or consumer. As used herein, the term “unintentional chemical contaminant” refers to an unintentional contaminant described by its chemical composition. As used herein, the term “unintentional contamination” refers to the sum of all unintentional contaminants and the term “unintentional chemical contamination” refers to the unintentional contamination described by its chemical composition.

As used herein, the term “degradation melting point” refers to the temperature at which the pulp begins to substantially degrade. The degradation may be determined through endothermic or exothermic processes.

As used herein, the term “limit of quantification” or “LOQ” refers to the lower detection limit for a given chemical contaminant as determined by the analytical methods disclosed in section IX. The LOQ is a function of the methods used and may vary from test method to test method. The LOQ used herein is specific to the method listed in section IX.

As used herein, the term “ppm” refers to mass parts per million, “ppb” refers to mass parts per billion, and “pptr” refers to mass parts per trillion.

“Sanitary tissue product” as used herein means a soft, low density (i.e. <about 0.60 g/cm³) web useful as a wiping implement for post-urinary and post-bowel movement cleaning (toilet tissue), for otorhinolaryngological discharges (facial tissue), and multi-functional absorbent and cleaning uses (absorbent towels). Non-limiting examples of suitable sanitary tissue products of the present invention include paper towels, bath tissue, facial tissue, napkins, baby wipes, adult wipes, wet wipes, cleaning wipes, polishing wipes, cosmetic wipes, car care wipes, wipes that comprise an active agent for performing a particular function, cleaning substrates for use with implements, such as a Swiffer® cleaning wipe/pad. The sanitary tissue product may be convolutedly wound upon itself about a core or without a core to form a sanitary tissue product roll.

“Basis Weight” as used herein is the weight per unit area of a sample reported in lbs/3000 ft² or g/m² and is measured according to the Basis Weight Test Method described herein.

“Machine Direction” or “MD” as used herein means the direction parallel to the flow of the fibrous structure through the fibrous structure making machine and/or sanitary tissue product manufacturing equipment.

“Cross Machine Direction” or “CD” as used herein means the direction parallel to the width of the fibrous structure making machine and/or sanitary tissue product manufacturing equipment and perpendicular to the machine direction.

“Ply” as used herein means an individual, integral fibrous structure.

“Plies” as used herein means two or more individual, integral fibrous structures disposed in a substantially contiguous, face-to-face relationship with one another, forming a multi-ply fibrous structure and/or multi-ply sanitary tissue product. It is also contemplated that an individual, integral fibrous structure can effectively form a multi-ply fibrous structure, for example, by being folded on itself.

The term “natural fibers” or “pulp fiber” as used herein, refers to fibers which comprise cellulose-based fibers, bamboo based fibers, and the like. Natural fibers also refers to nonwoody fibers, such as cotton, abaca, kenaf, sabai grass, flax, esparto grass, straw, jute hemp, bagasse, milkweed floss fibers, and pineapple leaf fibers; and woody, wood, or pulp fibers such as those obtained from deciduous and coniferous trees, including softwood fibers, such as northern and southern softwood kraft fibers; hardwood fibers, such as eucalyptus, maple, birch, and aspen. Pulp fibers can be prepared in high-yield or low-yield forms and can be pulped in any known method, including kraft, sulfite, high-yield pulping methods and other known pulping methods. The natural fibers of the present disclosure may be recycled natural fibers, virgin natural fibers or mixes thereof. Additionally, for good mechanical properties in natural fibers, it can be desirable that the natural fibers be relatively undamaged and largely unrefined or only lightly refined. The fibers can have a Canadian Standard Freeness of at least 200, more specifically at least 300, more specifically still at least 400, and most specifically at least 500.

The term “cellulose-based fibers,” as used herein, may include cellulose fibers such as wood fiber, cotton, regenerated cellulose fiber such as viscose, lyocell, rayon or cuprammonium rayon, and high pulping yield fibers, unless specified differently. The term “cellulose-based fibers” also includes chemically treated natural fibers, such as mercerized pulps, chemically stiffened or crosslinked fibers, or sulfonated fibers. Also included are mercerized natural fibers, regenerated natural cellulosic fibers, cellulose produced by microbes, the rayon process, cellulose dissolution and coagulation spinning processes, and other cellulosic material or cellulosic derivatives. Other cellulose-based fibers included are paper broke or recycled fibers and high yield fibers. High yield pulp fibers are those fibers produced by pulping processes providing a yield of about 65% or greater, more specifically about 75% or greater, and still more specifically about 75% to about 95%. Yield is the resulting amount of processed fibers expressed as a percentage of the initial wood mass. Such pulping processes include bleached chemithermomechanical pulp (BCTMP), chemithermomechanical pulp (CTMP), pressure/pressure thermomechanical pulp (PTMP), thermomechanical pulp (TMP), thermomechanical chemical pulp (TMCP), high yield sulfite pulps, and high yield Kraft pulps, all of which leave the resulting fibers with high levels of lignin but are still considered to be natural fibers. High yield fibers are well known for their stiffness in both dry and wet states relative to typical chemically pulped fibers.

The term “non-recyclable material” as used herein, refers to contaminants or materials which are believed to be unsuitable for processing in the natural fiber recycling process. However, in alternative recycling streams, the materials provided with this designation may be recyclable.

The recycle pulp of the present invention may be used to make fibrous structures.

Non-limiting examples of processes for making fibrous structures include known wet-laid processes, such as wet-laid papermaking processes, and air-laid processes, such as air-laid papermaking processes. Wet-laid and/or air-laid papermaking processes typically include a step of preparing a composition comprising a plurality of fibers that are suspended in a medium, either wet, more specifically aqueous medium, or dry, more specifically gaseous medium, such as air. The aqueous medium used for wet-laid processes is oftentimes referred to as a fiber slurry. The fiber composition is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g., a sanitary tissue product.

Non-limiting examples of other known processes and/or unit operations for making fibrous structures include fabric crepe and/or belt crepe processes, ATMOS processes, NTT processes, through-air-dried processes, uncreped through-air-dried processes, and conventional wet press processes.

The fibrous structures of the present invention may be homogeneous or may be layered in the direction normal to the machine direction. If layered, the fibrous structures may comprise at least two and/or at least three and/or at least four and/or at least five layers.

The fibrous structures of the present invention may be co-formed fibrous structures. “Co-formed” as used herein means that the fibrous structure comprises a mixture of at least two different components wherein at least one of the components comprises a filament, such as a polypropylene filament, and at least one other component, different from the first component, comprises a solid additive, such as a fiber and/or a particulate. In one example, a co-formed fibrous structure comprises solid additives, such as fibers, such as wood pulp fibers and/or absorbent gel articles of manufacture and/or filler particles and/or particulate spot bonding powders and/or clays, and filaments, such as polypropylene filaments. In yet another example, a co-formed structure comprises those described in U.S. Pat. Nos. 8,017,534 and 7,674,467.

Other non-limiting examples of pulp composition characteristics suitable for use herein are described in U.S. Pat. No. 11,252,966, the descriptions of which are incorporated herein by reference.

### II. Reclaimed Pulp

Post-consumer reclaimed pulps are generally more contaminated than pre-consumer reclaimed pulps due to extensive cross-contamination from unknown sources resulting in high levels of unintentional contamination.

Surprisingly, recycled pulp in the present invention may allow the use of reclaimed pulp from pre-consumer and post-consumer sources in applications requiring low chemical contamination such as medical and hygiene. In addition, most recycled pulp customers desire purer materials beyond what is available today and the recycled pulp (along with the associated packages and products containing these) of the present invention meets this requirement.

The reclaimed pulp may be in many macroscopic forms including but not limited to sheets, boards, rolls, etc.

The reclaimed pulp can be a second-life pulp (has been used only once before it entered the reclaimed pulp stream), third-life pulp (has been used twice before it entered the reclaimed pulp stream), or higher-life pulp fiber (has been used many times before it entered the reclaimed pulp stream).

The reclaimed pulp may comprise a regrind/edge-trim/in-plant waste pulp fiber or a post-industrial reclaimed pulp. The reclaimed pulp may comprise a post-industrial sheet or board.

The reclaimed pulp may comprise starch including but not limited to starches from various plants and chemically modified starches. The reclaimed pulp fiber may comprise polysaccharides, polylactic acid, polyhydroxyalkanoate, or chitin.

### III. Contaminants and Contamination

The chemical contaminants in the contaminated pulp/contaminated pulp composition may be numerous and fall into various chemical classes. These chemical classes may be benign while others may be more problematic. The chemical contaminants of importance herein include but are not limited to pesticides, aldehydes, allergic fragrances, izioalines, alkylphenol ethoxylates, alkylphenols, bisphenols, dioxins, dioxin-like, furans, PCBs, organotins, metals, phthalates, polyaromatic hydrocarbons (PAHs), and PFAs (including but not limited to polymeric PFAs). The concentration of these chemical contaminants are typically in the ppm, ppb, and pptr type of levels. The analytical methods used to measure these contaminants have lower sensitivity limits. These limits are referred to as Limit of Quantification (LOQ).

Using the analytical methods disclosed in section IX Methods, the LOQs of the various contaminants may differ by orders of magnitude. For example, the LOQ of a typical pesticide is about 10 ppb; the LOQ of typical alkylphenol ethoxylate is about 50 ppb; the LOQ of a typical alkylphenol is about 5 ppb; the LOQ of bisphenol-A is about 5 ppb; the LOQ of typical dioxin is about 0.2 pptr; the LOQ of a typical furan is about 0.2 pptr; the LOQ of a typical PCB is about 5 pptr; the LOQ of a typical heavy metal is about 100 ppb; the LOQ of a typical organotin is about 300 pptr; the LOQ of typical phthalate is 50 ppb; the LOQ of a typical PAH is 1 ppb.

Several wood pulp based papers (a pulp composition) including two containing only virgin pulp and one containing post-consumer reclaimed pulp, were broadly classified for chemical contamination using the analytical methods disclosed in section IX Methods, as shown in TABLE 1. Note: To simplify the presentation of chemical contamination results, the concentration data is displayed in terms of multiples of LOQ instead of absolute weight fraction involving ppm, ppb, or pptr description. For example, if the contaminant concentration is 10 ppm and the LOQ is 1 ppm, then the concentration would be 10×LOQ or just 10 displayed in the data tables.

TABLE 1
Chemical Contamination of Wood Pulp Based Papers

| | | | | Reclaimed |
|---|---|---|---|---|
| | | | | Post- |
| | | Virgin | | Consumer |
| | | #1 | #2 | #1 |
| | LOQ | xLOQ | xLOQ | xLOQ |
| Pesticides | | | | |
| Diethyltoluamide (DEET) | 10 ppb | <1 | <1 | 28.0 |
| Glyphosate | 10 ppb | <1 | <1 | 12.0 |
| Alkylphenol ethoxylates | | | | |
| iso-Nonylphenolmono- | 50 ppb | <1 | <1 | 4.0 |
| ethoxylate | | | | |
| iso-Nonylphenoldiethoxylate | 50 ppb | <1 | <1 | 6.2 |
| iso-Nonylphenoltriethoxylate | 50 ppb | <1 | <1 | 7.0 |
| iso-Nonylphenoltetra- | 50 ppb | <1 | <1 | 3.4 |
| ethoxylate | | | | |
| Bisphenols | | | | |
| Bisphenol A | 5 ppb | <1 | <1 | 32.0 |
| Dioxins and dioxinlike and | | | | |
| PCB | | | | |
| 1,2,3,4,6,7,8-HpCDD | 0.2 pptr | <1 | <1 | 145.5 |
| OCDD | 0.2 pptr | <1 | <1 | 1355.0 |
| OCDF | 0.2 pptr | <2 | <1 | 43.8 |
| PCB 81 | 0.05 pptr | <1 | <1 | 87.8 |
| PCB 105 | 5 pptr | ≤1 | <1 | 73.2 |
| PCB 118 | 10 pptr | <1 | <1 | 68.9 |
| Phthalates | | | | |
| Di-2-ethylhexyl phthalate | 50 ppb | <1 | <1 | 134.0 |
| Diisononyl phthalate | 50 ppb | <1 | <1 | 100.0 |
| PAHs | | | | |
| Fluoranthene | 1 ppb | <1 | <1 | 17.0 |
| Phenanthrene | 1 ppb | 1.7 | <1 | 13.0 |

In embodiments of the present invention, said chemical contaminants in said contaminated pulp or contaminated pulp composition include at least one chemical contaminant and such is selected from the group comprising pesticides, alkyl phenols, alkylphenol ethoxylates, bisphenols, dioxins, furans, PCBs, phthalates, PAHs, PFAs, or mixtures thereof.

In embodiments of the present invention, said chemical contaminants in said contaminated pulp or contaminated pulp composition include at least two chemical contaminants and such is selected from the group comprising pesticides, alkyl phenols, alkylphenol ethoxylates, bisphenols, dioxins, furans, PCBs, phthalates, PAHs, PFAs, or mixtures thereof.

In embodiments of the present invention, said chemical contaminants in said contaminated pulp or contaminated pulp composition include at least three chemical contaminants and such is selected from the group comprising pesticides, alkyl phenols, alkylphenol ethoxylates, bisphenols, dioxins, furans, PCBs, phthalates, PAHs, PFAs, or mixtures thereof.

In embodiments of the present invention, the contaminants in the contaminated pulp or contaminated pulp composition may comprise glyphosphate. In embodiments of the present invention, the contaminants in the contaminated pulp or contaminated pulp composition may comprise iso-Nonylphenolmonoethoxylate. In embodiments of the present invention, the contaminants in the contaminated pulp or contaminated pulp composition may comprise iso-Nonylphenoldiethoxylate. In embodiments of the present invention, the contaminants in the contaminated pulp or contaminated pulp composition may comprise iso-Nonylphenoltriethoxylate. In embodiments of the present invention, the contaminants in the contaminated pulp or contaminated pulp composition may comprise iso-Nonylphenoltetraethoxylate. In embodiments of the present invention, the contaminants in the contaminated pulp or contaminated pulp composition may comprise Bisphenol A. In embodiments of the present invention, the contaminants in the contaminated pulp or contaminated pulp composition may comprise OCDD. In embodiments of the present invention, the contaminants in the contaminated pulp or contaminated pulp composition may comprise OCDF. In embodiments of the present invention, the contaminants in contaminated pulp or contaminated pulp composition may comprise PCB 81. In embodiments of the present invention, the contaminants in contaminated pulp or contaminated pulp composition may comprise PCB 105. In embodiments of the present invention, the contaminants in contaminated pulp or contaminated pulp composition may comprise PCB 118. In embodiments of the present invention, the contaminants in the contaminated pulp or contaminated pulp composition may comprise di-2-ethylhexyl phthalate. In embodiments of the present invention, the contaminants in the contaminated pulp or contaminated pulp composition may comprise di-isononyl phthalate. In embodiments of the present invention, the contaminants in the contaminated pulp or contaminated pulp composition may comprise fluoranthene. In embodiments of the present invention, the contaminants in the contaminated pulp or contaminated pulp composition may comprise phenanthrene.

In general, the efficacy of the cleaning method of the present invention to remove a specific chemical contaminant is determined by the removal efficiency, defined as the difference in concentration of the chemical contaminant in the contaminated pulp/contaminated pulp composition and the concentration of the chemical contaminant in the purer pulp/purer pulp composition divided by the concentration of the chemical contaminant in contaminated pulp/contaminated pulp composition. However, the removal efficiency is somewhat insufficient due to the inability to determine any actual concentrations below the LOQ. For example, if a cleaning process reduces the contamination from 2×LOQ to less than the LOQ, then the true removal efficiency could range anywhere between 50% and 100%, which is a significant difference. Thus, the removal efficiency is only completely accurate when the contaminated pulp/contaminated pulp composition and the purer pulp/purer pulp composition concentration are both above LOQ. For simplicity, if the purer pulp/purer pulp composition has a chemical contaminant concentration below LOQ, then removal efficiency is calculated by assuming the chemical contaminant concentration of the purer pulp/purer pulp composition is at the LOQ and the removal efficiency is considered a minimum value and designated with >. For the above example, the removal efficiency would be calculated as 100(2×LOQ−1×LOQ)/(2×LOQ)=100(2−1)/2=50%. Thus, the removal efficiency would be listed as >50%. In certain cases, the purer pulp/purer pulp composition will have a higher level of a certain chemical contaminant than the initial contaminated pulp/contaminated pulp composition which contradicts the meaning of purer. This anomaly may be due to 1) measurement error/measurement variability, 2) contaminant hot spots and cold spots in the reclaimed pulp fiber, 3) external contamination during sampling, and 4) the purification process adds that specific contaminant. If this anomaly occurs consistently for a given chemical species for a given cleaning process, then such is more likely attributable to the purification process and should be more closely examined, but such was not generally the case for the cleaning processes of the present invention. Net, such isolated measurement anomalies were considered measurement error and not considered meaningful to the invention. In such cases, the removal efficiency is set to 0%.

In one embodiment, the removal efficiency of the DEET contaminant is >70% wherein said DEET concentration in the contaminated pulp/contaminated pulp composition is at least 10 parts per billion. In another embodiment of the present invention, the removal efficiency of the DEET contaminant is >85% wherein said DEET concentration in the contaminated pulp/contaminated pulp composition is at least 10 parts per billion.

In one embodiment of the present invention, the removal efficiency of the glyphosphate contaminant is >50% wherein said glyphosphate concentration in the contaminated pulp/contaminated pulp composition is at least 10 parts per billion. In another embodiment of the present invention, the removal efficiency of the glyphosphate contaminant is >90% wherein said glyphosphate concentration in the contaminated pulp/contaminated pulp composition is at least 10 parts per billion.

In one embodiment of the present invention, the removal efficiency of the iso-nonylphenolmonoethoxylate, iso-nonylphenoldiethoxylate, iso-nonylphenoltriethoxylate, and iso-nonylphenoltetraethoxylate contaminant are all >50% wherein said iso-nonylphenolmonoethoxylate, iso-nonylphenoldiethoxylate, iso-nonylphenoltriethoxylate, and iso-nonylphenoltetraethoxylate concentration in the contaminated pulp/contaminated pulp composition is at least 50 parts per billion. In another embodiment of the present invention, the removal efficiency of the iso-nonylphenolmonoethoxylate, iso-nonylphenoldiethoxylate, iso-nonylphenoltriethoxylate, and iso-nonylphenoltetraethoxylate contaminant are all >70% wherein said iso-nonylphenolmonoethoxylate, iso-nonylphenoldiethoxylate, iso-nonylphenoltriethoxylate, and iso-nonylphenoltetraethoxylate concentration in the contaminated pulp/contaminated pulp composition is at least 50 parts per billion.

In one embodiment of the present invention, the removal efficiency of the Bisphenol-A contaminant is >50% wherein said Bisphenol-A concentration in the contaminated pulp/contaminated pulp composition is at least 5 parts per billion. In another embodiment of the present invention, the removal efficiency of the Bisphenol-A contaminant is >95% wherein said Bisphenol-A concentration in the contaminated pulp/contaminated pulp composition is at least 5 parts per billion.

In one embodiment of the present invention, the removal efficiency of the 1,2,3,4,6,7,8-HpCDD contaminant is >50% wherein said 1,2,3,4,6,7,8-HpCDD concentration in the contaminated pulp/contaminated pulp composition is at least 0.2 parts per trillion. In another embodiment of the present invention, the removal efficiency of the 1,2,3,4,6,7,8-HpCDD contaminant is >85% wherein said 1,2,3,4,6,7,8-HpCDD concentration in the contaminated pulp/contaminated pulp composition is at least 0.2 parts per trillion.

In one embodiment of the present invention, the removal efficiency of the OCDD contaminant is >50% wherein said OCDD concentration in the contaminated pulp/contaminated pulp composition is at least 0.2 parts per trillion. In another embodiment of the present invention, the removal efficiency of the OCDD contaminant is >85% wherein said OCDD concentration in the contaminated pulp/contaminated pulp composition is at least 0.2 parts per trillion.

In one embodiment of the present invention, the removal efficiency of the PCB 81 contaminant is >50% wherein said PCB 81 concentration in the contaminated pulp/contaminated pulp composition is at least 0.05 parts per trillion. In another embodiment of the present invention, the removal efficiency of the PCB 81 contaminant is >85% wherein said PCB 81 concentration in the contaminated pulp/contaminated pulp composition is at least 0.05 parts per trillion.

In one embodiment of the present invention, the removal efficiency of the PCB 105 contaminant is >50% wherein said PCB 105 concentration in the contaminated pulp/contaminated pulp composition is at least 5 parts per trillion. In another embodiment of the present invention, the removal efficiency of the PCB 105 contaminant is >85% wherein said PCB 105 concentration in the contaminated pulp/contaminated pulp composition is at least 5 parts per trillion.

In one embodiment of the present invention, the removal efficiency of the PCB 118 contaminant is >50% wherein said PCB 118 concentration in the contaminated pulp/contaminated pulp composition is at least 10 parts per trillion. In another embodiment of the present invention, the removal efficiency of the PCB 118 contaminant is >85% wherein said PCB 118 concentration in the contaminated pulp/contaminated pulp composition is at least 10 parts per trillion.

In embodiments of the present invention, the removal efficiency of the Di-2-ethylhexyl phthalate contaminant is >50% wherein said Di-2-ethylhexyl phthalate concentration in the contaminated pulp/contaminated pulp composition is at least about 50 parts per billion. In another embodiment of the present invention, the removal efficiency of the Di-2-ethylhexyl phthalate contaminant is >85% wherein said Di-2-ethylhexyl phthalate concentration in the contaminated pulp/contaminated pulp composition is at least about 50 parts per billion.

In embodiments of the present invention, the removal efficiency of the Di-isononyl phthalate contaminant is >50% wherein said Di-isononyl phthalate contaminant concentration in the contaminated pulp/contaminated pulp composition is at least about 50 parts per billion. In another embodiment of the present invention, the removal efficiency of the Di-isononyl phthalate contaminant is >85% wherein said Di-isononyl phthalate contaminant concentration in the contaminated pulp/contaminated pulp composition is at least about 50 parts per billion.

In embodiments of the present invention, the removal efficiency of the fluoranthene contaminant is >50% wherein said fluoranthene concentration in the contaminated pulp/contaminated pulp composition is at least about 1 parts per billion. In another embodiment of the present invention, the removal efficiency of the fluoranthene contaminant is >85% wherein said fluoranthene concentration in the contaminated pulp/contaminated pulp composition is at least about 1 parts per billion.

In embodiments of the present invention, the removal efficiency of the phenanthrene contaminant is >50% wherein said phenanthrene concentration in the contaminated pulp/contaminated pulp composition is at least about 1 parts per billion. In another embodiment of the present invention, the removal efficiency of the phenanthrene contaminant is >85% wherein said phenanthrene concentration in the contaminated pulp/contaminated pulp composition is at least about 1 parts per billion.

In embodiments of the present invention, the removal efficiency of the Perfluorooctanoic acid contaminant is >50% wherein said Perfluorooctanoic acid concentration in the contaminated pulp/contaminated pulp composition is at least LOQ. In embodiments of the present invention, the removal efficiency of the Perfluorooctane sulfonic acid contaminant is >50% wherein said Perfluorooctane sulfonic acid concentration in the contaminated pulp/contaminated pulp composition is at least LOQ.

In general, bulk contamination will not be appreciably removed by simple aqueous surface washing approaches of the prior art. Permeable bulk contamination can be removed by diffusion mechanisms through gradients in chemical potential, whereas bulk impermeable contamination is essentially trapped by the bulk pulp fiber, and methods to free the trapped contaminant dissolution/disintegration of the pulp fiber.

### IV. Surface Purification Methods

Surface purification methods reduce surface contamination. One example of a purification process may include, but is not limited to, surface washing with a surface washing fluid that is typically water based. The reclaimed pulp fiber will generally be in the form of board, loose or compacted fibers, loose or compacted flexible packages, loose or compacted rigids, loose or compacted non-wovens, loose or compacted fibers, etc., which will be difficult to surface wash due to excessive overall size. Hence, prior to surface washing, a granulation or shredding step is preferred. The surface washing will typically include mechanical agitation to loosen surface dirt and other contaminants to allow physical removal and transfer to the washing fluid wherein the dirt or other contaminants may or may not solubilize.

Surface washing technologies are available extensively on the market for cellulosic-based reclaimed pulp fibers.

### V. Bulk Purification

In general, bulk contamination will not be appreciably reduced by simple aqueous surface washing.

One example of a purification process may include, but is not limited to, extraction, which may be a preferred bulk purification method for removing permeable contaminants. Extraction involves the use of a purification solvent to remove bulk permeable contaminants through creation of a chemical potential gradient between the reclaimed pulp fiber and the solvent. The rate of permeable chemical contaminant removal will depend upon the diffusivity and solubility of the contaminant in the pulp fiber under the conditions created in the process. For high molecular weight pulp fibers, the diffusivity of large molecules indicative of chemical contaminants is quite low, especially in the solid state of the pulp fiber. In addition, the solubility may be limited due to the high MW of the reclaimed pulp fiber and lack of enthalpic mixing. Thus, the time required to remove permeable contaminants through diffusion mechanisms can be quite long and not conducive to economically viable processes at commercial scale. Methods to resolve these time scale limitations include 1). increased diffusivity through elevated temperature and/or pulp fiber relaxation through solvent swelling, 2). decrease of diffusion path length through increased surface area to volume ratio of the reclaimed pulp fiber exposed to the solvent, 3) increased convective transport of the contaminant through the pulp fiber/solvent interface by: increased solubility of the contaminant in the solvent, increased partitioning of the contaminant within the solvent relative to the pulp fiber; increased convection around the pulp fiber/solvent interface, and increased solvent sink relative to pulp fiber sink. The solubility of the bulk purification solvent in the pulp fiber can be increased by operating the extraction at high pressures especially at, near, or above the critical pressure.

It is important for the extraction method to be scalable to large volumes at low cost. Hence, the time required for extraction should be low to allow for such scalability. In embodiments of the present invention, the total time for extraction is less than about 6 hours, preferably less than about 4 hours, more preferably less than about 2 hours, and even more preferably less than about 1 hour. If the extraction is completed in stages, then the time per stage may be less than this range but the overall time will still fall within these times.

Extractions may take place above, near, at, or below the degradation or primary melting point (whichever is lower) of the reclaimed pulp fiber. Extractions generally occur in a two-phase system involving a solvent-rich phase and a pulp fiber-rich phase. Leaching extractions are a subset of extractions typically involving a liquid state for the solvent-rich phase and a solid state for the pulp fiber-rich phase. Liquid-liquid extractions are a subset of extractions typically involving two liquid states. In an embodiment of the present invention, the extraction is leaching.

In leaching processes, the reclaimed pulp fiber may be contacted with excessive solvent during every stage and every time of the process. Such leaching processes are called flooded leaching processes. In flooded leaching processes, the mass of leaching solvent to mass of reclaimed pulp fiber exposed to the solvent at every point in time and in every stage of the process is preferably equal to or greater than about 5:1. In certain flooded leaching processes, the solvent is rapidly stirred such that the reclaimed pulp fiber is suspended in the solvent even when the density of the reclaimed pulp fiber is greater than the solvent. Such flooded leaching processes 1) ensure complete contact between the surface of the reclaimed pulp fiber and the leaching solvent and 2) lower the mass transfer resistance within the solvent boundary layer around the reclaimed pulp fiber surface due to the convective motion. Beyond stirring, similar reduced boundary layer may be achieved in flooded leaching processes by allowing the reclaimed pulp fiber to settle through the solvent by density gradient. Examples of flooded leaching processes include stirred tanks of the continuous, semi-continuous, and batch types. Additional examples of flooded leaching processes include settling tanks wherein the reclaimed pulp fiber is allowed to settle out or through the solvent that is filled inside a tank or other vessel.

In leaching processes, the solvent may be contacted with excessive pulp fiber during every stage and every time of the process. Such leaching processes are called packed leaching processes. In packed leaching processes of the current invention, the mass of leaching solvent to mass of reclaimed pulp fiber exposed to the solvent at every point in time and in every stage of the process is preferably equal to or less than about 5:1. In certain packed leaching processes, the solvent is flowed through a packed column or bed of pulp fiber. Such packed leaching processes provide efficient means for removing contaminated solvent and ensuring optimal concentration gradient. Examples of packed leaching include but are not limited due flow through packed beds, percolation extractors, screw-based extractors, Hildebrandt extractors, etc.

In some embodiments, a purification process may include an extraction that comprises flooded leaching. In embodiments of the present invention, the extraction may comprise packed leaching. In embodiments of the present invention, the extraction comprises a combination of flooded and packed leaching.

For leaching processes of the current invention, it may be beneficial to select a leaching solvent and operating temperature and pressure such that the leaching solvent is at its boiling point during the extraction. Such designs allow the solvent to be continuously refluxed, which may enable locally high concentration gradients as the refluxed solvent contacts the reclaimed pulp fiber. In embodiments of the present invention, the bulk extraction is either packed or flooded leaching or combinations of both, and the pressure of the bulk purification is about atmospheric. In embodiments of the present invention, the bulk extraction is either packed or flooded leaching or combinations of both, and the pressure of the leaching is about atmospheric, and the leaching solvent is at or near the normal boiling point. For cellulosics, preferred leaching solvents for flooded leaching have boiling points in the 2 °C to 90 °C range. Examples of such solvents are THF, di-ethyl ether, hexanes, acetone, ethanol, methanol, propanol, iso-propanol, MEK, and ethyl acetate or blends thereof. The leaching solvents may contain minor amounts of water (<~25 wt % water) that are residual within the cellulosic reclaimed pulp fiber or intentionally added to any of the aforementioned solvents. In embodiments of the present invention, said leaching solvent may have a normal boiling point between 20 °C and 90 °C. In embodiments of the present invention, the leaching solvent has a normal boiling point between 20 °C and 90 °C and the leaching temperature is at or near the boiling point. In another embodiment of the present invention, the leaching solvent has a normal boiling point between 20 °C and 90 °C and the purification temperature is at or near the boiling point and the pressure is at or near atmospheric. The pressure may also be between about 0.5 atm and higher. In yet another embodiment of the present invention, the leaching solvent has a normal boiling point between 20 °C and 90 °C and the pressure is above atmospheric but below 1,000 atm. The leaching solvent may also have a boiling point above the leaching temperature. In even yet another embodiment of the present invention, the leaching solvent has a normal boiling point above the leaching temperature. In another embodiment of the present invention, wherein said bulk purification is leaching; wherein said leaching solvent is ethyl acetate; said temperature of said leaching is between about 20 °C and about 120 °C; and said pressure of said leaching is between about 0.5 atm and about 1,000 atm. In another embodiment of the present invention, wherein said bulk purification is leaching; wherein said leaching solvent is hexanes; said temperature of said leaching is between about 20 °C and about 120 °C; and said pressure of said leaching is between about 0.5 atm and about 1,000 atm.

Leaching solvents with a normal boiling point below the leaching temperature are also preferred due to the elevated leaching pressures. In embodiments of the present invention, the leaching solvent has a normal boiling point below the leaching temperature. In another embodiment of the present invention, the leaching solvent is di-methyl ether (DME). In an embodiment of the present invention, wherein said bulk purification is leaching; wherein said leaching solvent is DME; said temperature of said leaching is between about 20 °C and about 120 °C; and said pressure of said leaching is between about 2 atm and about 1,000 atm.

Preferred leaching solvents include solvents that have higher affinity for the chemical contaminants than for the reclaimed pulp fiber. Solvents with high affinity for the chemical contaminants include but are not limited to diethyl ether, MEK, ethyl acetate, THF, acetone, methylene chloride, iso-propanol, propanol, ethanol, and methanol. Other oxygenated and polar hydrocarbon solvents likely have similar desired affinity. Solvents lacking such characteristics can still be used, but higher solvent to pulp fiber ratios may be required. It is preferred that the solvent should not significantly dissolve the reclaimed pulp fiber at the temperature and pressure of the process (<~5 wt % may be dissolved). The solvent may slightly swell the reclaimed pulp fiber but not enough to cause agglomeration or coalescence. The solvents may contain water for various functional or non-functional reasons (below ~25 wt %).

In embodiments of the present invention, said leaching solvent is selected from the group comprising hydrocarbons. In another embodiment of the present invention, said leaching solvent is selected from the group comprising aliphatic hydrocarbons. In even another embodiment of the present invention, said leaching solvent is selected from the group comprising aromatic hydrocarbons. In even yet another embodiment of the present invention, said leaching solvent is selected from the group comprising alkanes.

In embodiments of the present invention, said leaching solvent is selected from the group comprising methane, ethane, propane, normal butane, isobutane, normal pentane, isopentane, neopentane, hexanes (normal hexane, isohexane, neohexane, heptanes), octanes, or mixtures thereof.

The temperature may be changed during the course of the extraction process but is generally consistent within a given stage of a unit operation. The pressure may be changed to vary solubility of the solvent in the reclaimed pulp fiber or to increase solubility of the chemical contaminant within the solvent.

A leaching extraction process may take place in stages and be combined with additional leaching extraction processes of other types not discussed in this application. The same is true for liquid-liquid extraction processes. In addition, liquid-liquid process may be combined with leaching process in various stages to form a given purification process. In embodiments of the present invention, the number of stages is one or more than one. In another embodiment of the present invention, the number of liquid-liquid stages is more than one. In yet another embodiment of the present invention, the number of leaching stages is more than one. In still yet another embodiment of the present invention, the number of liquid-liquid stages is one or more and the number of leaching stages is one or more. A single stirred tank reactor will achieve a certain removal efficiency. The efficiency can be improved by having multiple stirred tank reactors in series wherein the reclaimed pulp fiber from the 1^{st} stage is predominately separated from the 1^{st} stage purification solvent and this 1^{st} stage pulp fiber is used in the 2nd stage with fresh purification solvent. This is repeated for each additional stage. This method improves the removal efficiency at the expense of additional reactors and complexity but maintains the overall time, throughput, and solvent utilization. Practically speaking, the number of reactor stages can be anywhere from 1 to ~10 for stirred tank systems. If a larger number of stages are needed, then a continuous counter-current method may be used.

While not wishing to be bound by theory, the theoretical maximum contaminant removal capacity for a leaching process is based upon the thermodynamic equilibrium/partitioning of the chemical contaminants between the reclaimed pulp fiber and leaching solvent at the temperature and pressure of the process. Thermodynamic equilibrium may not be achieved due to kinetic limitations in the leaching process. This is true for the complete leaching process and is also true for each leaching stage. A higher leaching solvent to reclaimed pulp fiber mass ratio will drive both thermodynamics and kinetics in favor of purification at the expense of greater solvent consumption and greater extraction process size, which equals greater cost. Thus, a balance must be found between these important design and operational variables for the targeted chemical contaminant removal efficiency. In addition, the contaminated solvent from any stage may be used “as-is” as the solvent for another stage. Contaminated solvent at any point in the process may be renewed through known methods of distillation, filtration, ion-exchange, etc., or combinations.

Another important kinetic driver is surface area to volume ratio of the reclaimed pulp fiber within and exposed to the leaching solvent. In general, the time required to extract a chemical contaminant from a reclaimed pulp fiber is a strong function of the diffusion pathlength within the reclaimed pulp fiber. The diffusion pathlength is indirectly proportional to the surface area to volume ratio of the geometrical form of the reclaimed pulp fiber and the ability to access the surface area with leaching solvent. Hence, a higher surface area to volume ratio will produce a reduced diffusion pathlength and faster diffusion kinetics. For leaching processes, a high surface area to volume ratio is a critical parameter for quick and efficient contaminant removal both surface and bulk.

A known means for increasing the effective mass transfer through a given surface area to volume ratio and given set of conditions at the reclaimed pulp fiber solvent interface is through applying energy to the reclaimed pulp fiber such as but not limited to vibrational in the form of ultrasonic energy and/or microwave.

Following the bulk purification involving extraction, the pulp fiber may be devolatilized to produce a purer recycled pulp fiber. The contaminated solvent will contain a small amount of dissolved purer recycled pulp fiber, the extracted contaminants, and the pure leaching solvent. There are many ways to recover the purer recycled pulp fiber and bulk purification solvent independent of the extracted contaminants.

In general, a small amount of reclaimed pulp fiber may dissolve into the leaching solvent regardless of process type or solvent. In particular, low molecular weight waxes are particularly prone to solubilization into the extracting solvent. These may become problematic in distillation-based recovery of the purified solvent due to deposition of the waxes on process equipment. Methods are known to reduce this tendency. One such method is to lower the temperature of the contaminated solvent to below the cloud point to precipitate the pulp fiber or wax phase followed by filtration. Unlike the reclaimed pulp fiber, the residual pulp fiber or waxes resulting pulp fiber from the precipitation from the contaminated solvent may contain significant chemical contamination.

Distillation and/or flash evaporation of the contaminated bulk purification solvent may be used to regenerate the solvent for re-use in the various extraction operations. However, distillation may not be economically feasible on-going considering the high solvent volume utilized in the present invention. In addition, because the chemical contaminants of interest in this invention are extremely low in concentration, the concentration of these chemical contaminants in the contaminated solvent may be correspondingly low or even lower. Thus, a preferred method to purify the contaminated solvent is through direct removal of the contaminants without volatilizing the bulk solvent phase. Such methods include precipitation, ion exchange, adsorption/absorption methods, etc. Non-limiting examples include passing the contaminated solvent through a bed of activated carbon or alumina. This method can be used alone or in combination with distillation to achieve the right level of purification at the right energy consumption. In addition, the contaminated solvent from any stage may be used “as-is” as the solvent for another stage. Contaminated solvent at any point in the process may be renewed through known methods of distillation, filtration, ion-exchange, etc., or combinations.

The purer recycled pulp fiber may contain small amounts of the solvent in either physically adsorbed or bulk absorbed form. The concentration of the solvent in the purer recycled pulp fiber may be reduced by devolatilization techniques. In an embodiment of the present invention, said purer recycled pulp fiber is devolatilized to a content of <1 wt % solvent. In an embodiment of the present invention, said purer recycled pulp fiber is devolatilized to a content of <about 50 ppm solvent.

Multi-staged stirred tank flooded extractors operating at the boiling point of a polar organic leaching solvent provide improvements in chemical contaminant removal over existing methods. For example (as shown in Examples 1 and 2), a flooded leaching process of the present invention provided targeted contaminant removal efficiencies greater than about 50%.

In embodiments of the present invention, the leaching solvent is ethyl acetate. In yet another embodiment of the present invention, the leaching solvent is ethyl acetate and the process pressure is about atmospheric pressure. In another embodiment of the present invention, said bulk purification comprises flooded leaching in a stirred tank conducted at about 77.1 °C and about atmospheric pressure with a leaching solvent comprising ethyl acetate.

In embodiments of the present invention, the leaching solvent is acetone. In yet another embodiment of the present invention, the leaching solvent is acetone and the process pressure is about atmospheric pressure. In another embodiment of the present invention, said bulk purification comprises flooded leaching in a stirred tank conducted at about 56.1 °C and about atmospheric pressure with a leaching solvent comprising acetone.

In another embodiment of the present invention (Example 1 and Tables), a bulk purification of a reclaimed pulp fiber involving recycled cellulosic paperboard comprises flooded leaching in a stirred tank involving 4 stages conducted at about 77.1 °C and about atmospheric pressure with a leaching solvent comprising ethyl acetate; wherein the ethyl acetate to first pulp fiber mass ratio is ~10:1 per stage for a leaching time of ~30 minutes per stage for a total ethyl acetate to recycled pulp fiber ratio of about 40:1 and a total leaching time of about 120 minutes; wherein the % removal of the pesticides, DEET and glyphosphate, is 52.7 and >86.7%, the alkylphenolethoxylates, isononylphenoldiethoxylate and isononylphenoltriethoxylate, is >94.6% and >96.2%, the alkylphenols, isononylphenol and 4-tert-pentylphenol, is >78.3% and 80.8%, the bisphenol A is >98.7%, the dioxins, 1,2,3,4,6,7,8-HpCDD and OCDD, is 74.3% and 84.3%, the OCDF is 87.1%, the PCBs, PCB 105 and PCB 118, is 89.4% and 89.5%, the organotins, dimethyltin and trimethyltin, is 98.4% and 99.5%, the phthalates, Di-2-ethylhexylphthalate and diisononylphthalate, is 98.1% and 94.0%, and the PAHs, fluoranthene and phenanthrene, is >94.1% and 86.9% wherein the initial concentration of these contaminants in the reclaimed pulp fiber are above LOQ.

In another embodiment of the present invention (Example 2 and Tables), a bulk purification of a reclaimed pulp fiber involving a different recycled paperboard comprises flooded leaching in a stirred tank involving 4 stages conducted at about 77.1 °C and about atmospheric pressure with a leaching solvent comprising ethyl acetate; wherein the ethyl acetate to first pulp fiber mass ratio is ~10:1 per stage for a leaching time of ~30 minutes per stage for a total ethyl acetate to reclaimed pulp fiber ratio of about 40:1 and a total leaching time of about 120 minutes; wherein the % removal of the pesticides, DEET, is >47.4%, the alkylphenol, 4-tert-pentylphenol, is >70.6%, the dioxins, 1,2,3,4,6,7,8-HpCDD and OCDD, is 59.4% and 67.5%, the OCDF is 67.3%, the PCBs, PCB 105 and PCB 118, is 78.9% and 79.6% wherein the initial concentration of these contaminants in the reclaimed pulp fiber are significantly above LOQ. The mechanical properties of paperboard produced from the purer cellulosic recycled pulp fiber are not significantly reduced compared to similar paperboard produced from the reclaimed pulp fiber (% decrease in properties <10%).

Following the flooded leaching, the purer recycled pulp fiber may be physically wetted with the residual solvent and potentially contain a small amount of absorbed solvent. As discussed earlier, there are many ways to recover the purer recycled pulp fiber and bulk purification solvent independent of the extracted contaminants. The purer recycled pulp fiber can be dried and devolatilized by many known commercial means. One method is through cyclonic drying. Another method is through melt extrusion with a devolatilization section. In embodiments of the present invention, the purer recycled pulp fiber is processed to reduce the leaching solvent to below about 1 wt % in the reclaimed pulp fiber and more preferably less than about 50 ppm. The contaminated solvent can be cleaned with known methods of distillation, ion exchange, filtration, etc. The resulting devolatilized reclaimed pulp fiber may be used as it or may be further processed into other forms including pellets via various processes.

### VI. Recycled Pulp Fiber

The purer recycled pulp fiber produced from the reclaimed pulp fiber will have a lower level of contamination relative to the reclaimed pulp fiber. The purer recycled pulp fiber from the bulk purification step may be further processed to produce other forms.

### VII. Examples

In general, the established methods for purifying/cleaning reclaimed pulp fiber including water washing are currently not able to sufficiently remove chemical contaminants. Net, there is an unmet need for a cleaning technology that is capable of more completely removing chemical contamination sufficient for highly contaminated sources and for any market desiring purer recycled materials. In addition, there is an unmet need for recycled compositions that do not have, or have very low levels of, chemical contaminations.

### Comparative Example—Purification Method Using Traditional Water Washing of Reclaimed Post-Consumer Pulp Composition in Paperboard Form to Produce a Water-Washed Post-Consumer Recycled Pulp Composition

2,500 grams of de-ionized water was added to a 5 L stirred round bottom flask. In addition, 1 mL of Triton X=100 surfactant was added to the water. The flask was outfitted with a mechanical stirrer, one reflux condenser, and one heat jacket. The mechanical stirring was set to 400 rpm. The heating jacket was controlled by a variable voltage transformer. The heat was applied to rapidly bring the water to ~80 °C) in about 5 minutes. After reaching ~80 °C, the heat input was lowered to maintain a constant temperature of ~80 °C. Contaminated pulp composition in the form of Reclaimed Post-Consumer Paper was cut into 1 cm×1 cm squares. The ~250 grams of the cut Reclaimed Post-Consumer Paper was added to the round bottom flask which contained the hot water/surfactant solution. The washing was continued for ~30 minutes. The stirring was terminated, and the heat was removed. The water solution was decanted from the mixture of solids and liquids. This completed washing step #1.An additional 2,500 grams of preheated water/Triton X-100 solution was added to the paperboard in the 5 L round bottom to complete a second washing step. Stirring was started at 400 to 500 rpm while heating was applied sufficient to achieve ~80 °C. The time to reach 80 °C after the addition of the fresh-water solution to the paperboard was ~5 minutes. The 2nd washing continued for a total of ~30 minutes. The stirring was stopped, and the heat removed. The water solution was decanted off. This completed washing step #2.An additional 2,500 grams of preheated water/Triton X-100 solution was added to the paperboard in the 5 L round bottom. Stirring was started at 400 to 500 rpm while heating was applied sufficient to achieve 80 °C. The time to reach ~80 °C after the addition of fresh-water solution was ~5 minutes. This washing step continued for a total of ~30 minutes. The stirring was stopped, and the heat removed. The water solution was decanted off. This completed washing step #3.An additional 1,000 grams of preheated fresh water/Triton X-100 solution was added to the paperboard in the 5 L round bottom to complete a fourth washing step. Stirring was started at 400 to 500 rpm while heating was applied sufficient to achieve ~80 °C in the water solution. The time to reach ~80 °C after the addition of fresh-water solution was ~5 minutes. The 4th washing continued for a total of ~30 minutes. The stirring was stopped, and the heat removed. The water solution was decanted off. The paperboard contained a small amount of contaminated water solution within the porosity of the paperboard. This wet paperboard was placed in a filter funnel with 60 mesh grating to further remove residual water solution via gravity. The paperboard was then completely dried of contaminated water solution at room temperature over-night to produce the purer pulp composition. The washing solution to pulp composition ratio per stage was ~10:1 for four stages giving a total washing solution to pulp composition ratio of ~40:1. The washing time per stage was approximately ~35 minutes per stage for a total time of ~140 minutes. The contaminated pulp composition represented by Reclaimed Post-Consumer Pulp and the resulting purer pulp composition represented by the Recycled Post-Consumer Pulp discussed above was analyzed for the classes of chemical contaminants typically present in recycled materials by GALAB Laboratories GmbH (Am Schleusengraben 7, 21029 Hamburg, Germany) using the methods disclosed in section IX Methods, as shown in Table 2. For the contaminants DEET, glyphosphate, isononylphenolmonoethoxylate, isononylphenoldiethoxylate, isononylphenoltriethoxylate, isononylphenoltetraethoxylate, bisphenol A, 1,2,3,4,6,7,8-HpCDD, OCDD, OCDF, PCB 81, PCB 105, PCB 118, di2-ehtylhexylphthalate, and diisononylphthalate, the % removal was >96.4%, 44.2%, 35.0%, 35.5%, 40.0%, 17.6%, 72.5%, 0.0%, 0.0%, 0.0%, 0.0%, 0.0%, 0.0%, 14.9%, and 10.0% respectively, which was indicative of generally poor contaminant removal especially for the dioxins, pcbs, and phthalates.

The pulp before and after the purification was characterized for water retention value. The water wash resulted in a 10.4% reduction of water-retention value which may be indicative of increased hornification.

The pulp before and after the purification were processed into handsheets following Tappi T205 and then evaluated for tensile properties and chemical composition. The tensile strength for the handsheets after purification was reduced by about 11% possibly due to increased hornification. The washing process removed about 6.5% ash but didn't significantly remove lignin from the pulp fibers.

TABLE 2
Purification Method Using Traditional Water Washing of Reclaimed Post-Consumer Pulp Composition
in Paperboard Form to Produce a Water-Washed Post-Consumer Recycled Pulp Composition

| | | Reclaimed Post-Consumer Pulp Composition | | |
|---|---|---|---|---|
| | | Before | After | |
| | | Purification | Purification | % |
| | LOQ | xLOQ | xLOQ | Removed |
| Pesticides | | | | |
| Diethyltoluamide (DEET) | 10 ppb | 28.0 | <1 | >96.4% |
| Glyphosate | 10 ppb | 12.0 | 6.7 | 44.2% |
| Alkylphenol ethoxylates | | | | |
| iso-Nonylphenolmonoethoxylate | 50 ppb | 4.0 | 2.6 | 35.0% |
| iso-Nonylphenoldiethoxytate | 50 ppb | 6.2 | 4.0 | 35.5% |
| iso-Nonylphenoltriethoxylate | 50 ppb | 7.0 | 4.2 | 40.0% |
| iso-Nonylphenoltetraethoxylate | 50 pob | 3.4 | 2.8 | 17.6% |
| Bisphenols | | | | |
| Bisphenol A | 5 ppb | 32.0 | 8.8 | 72.5% |
| Dioxins and dioxinlike and PCB | | | | |
| 1,2,3,4,6,7,8-HpCDD | 0.2 pptr | 145.5 | 163.0 | 0.0% |
| OCDD | 0.2 pptr | 1355.0 | 1445.0 | 0.0% |
| OCDF | 0.2 pptr | 43.8 | 47.7 | 0.0% |
| PCB 81 | 0.05 pptr | 87.8 | 92.8 | 0.0% |
| PCB 105 | 5 pptr | 73.2 | 87.2 | 0.0% |
| PCB 118 | 10 pptr | 68.9 | 83.2 | 0.0% |
| Phthalates | | | | |
| Di-2-ethylhexyl phthalate | 50 ppb | 134.0 | 114.0 | 14.9% |
| Diisononyl phthalate | 50 ppb | 100.0 | 90.0 | 10.0% |
| Polycyclic aromatic hydrocarbons (PAH) | | | | |
| Fluoranthene | 1 ppb | 17.0 | dnt | n.a. |
| Phenanthrene | 1 ppb | 13.0 | dnt | n.a. |
| | | | | % Increase |
| Water Retention Value (g/g) | | 1.25 +/− 0.1 | 1.12 +/− 0.01 | −10.4% |
| FQA Fines Levet (%) | | 9.4 +/− 0.0 | 10.1 +/− 0.2 | 7.4% |
| Handsheet Tensile Strength (kN/m) | | 1.8 +/− 0.1 | 1.6 +/− 0.1 | −11.1% |
| Handsheet Zero Span Tensile Strength (kg [symbol] ) | | 8.41 +/− 0.32 | 8.20 +/− 0.34 | −2.5% |
| Compositional Information | wt % | | | % Removed |
| Ash(%) | | 6.2 | 5.8 | 6.5% |
| Klason Lignin (%) | | 14.2 +/− 0.1 | 14.3 +/− 0.3 | −0.7% |
| Acid soluble Lignin (%) | | 0.9 +/− 0.0 | 0.9 +/− 0.1 | 0.0% |
| % Lignin Level | | 15.2 +/− 0.1 | 15.2 +/− 0.3 | 0.0% |

[symbol]

indicates data missing or illegible when filed

### Inventive Example 1—Ethyl Acetate Leaching of Reclaimed Post-Consumer Pulp Composition in Paperboard Form to Produce a Purified Post-Consumer Recycled Pulp Composition

2,500 grams of ethyl acetate was added to a 5 L stirred round bottom flask. The flask was outfitted with a mechanical stirrer, one reflux condenser, and one heat jacket. The mechanical stirring was set to 400 rpm. The heating jacket was controlled by a variable voltage transformer. The heat was applied to rapidly bring the ethyl acetate to boiling (~77.1 °C) in about 5 minutes. After reaching the boiling point of ethyl acetate, the heat input was lowered to achieve a consistent reflux rate of ~10 ml/min at the boiling point of ~77.1 °C. Contaminated pulp composition in the form of Reclaimed Post-Consumer Pulp Composition in paperboard form was cut into 1 cm×1 cm squares. The ~250 grams of the cut Reclaimed Post-Consumer Pulp Composition in paperboard form was added to the round bottom flask which contained the boiling ethyl acetate. The extraction was continued for ~30 minutes. The stirring was terminated, and the heat was removed. The ethyl acetate was decanted from the mixture of solids and liquids. An additional 2,500 grams of preheated fresh ethyl acetate at or near the boiling point was added to the paperboard in the 5 L round bottom to complete a second extraction step. Stirring was started at 400 to 500 rpm while heating was applied sufficient to reflux the ethyl acetate at ~10 mL/min. The time to reach reflux after the addition of fresh ethyl acetate to the paperboard was ~5 minutes. The 2nd extraction continued for a total of ~30 minutes. The stirring was stopped, and the heat removed. The ethyl acetate was decanted off. An additional 2,500 grams of preheated fresh ethyl acetate at or near the boiling point was added to the paperboard in the 5 L round bottom to complete a third extraction step. Stirring was started at 400 to 500 rpm while heating was applied sufficient to reflux the ethyl acetate at ~10 mL/min. The time to reach reflux after the addition of fresh ethyl acetate to the paperboard was ~5 minutes. The 3rd extraction continued for a total of ~30 minutes. The stirring was stopped, and the heat removed. The ethyl acetate was decanted off. An additional 2,500 grams of preheated fresh ethyl acetate at or near the boiling point was added to the paperboard in the 5 L round bottom to complete a fourth extraction step. Stirring was started at 400 to 500 rpm while heating was applied sufficient to reflux the ethyl acetate at ~10 mL/min. The time to reach reflux after the addition of fresh ethyl acetate to the paperboard was ~5 minutes. The 4th extraction continued for a total of ~30 minutes. The stirring was stopped, and the heat removed. The ethyl acetate was decanted off. The paperboard contained a small amount of contaminated solvent residual within the porosity of the paperboard. This wet paperboard was placed in a filter funnel with 60 mesh grating to further remove residual ethyl acetate via gravity. The paperboard was then completely dried of contaminated solvent at room temperature over-night to produce the Purified Pulp Composition or specifically Recycled Post-Consumer Pulp. The leaching solvent to pulp composition ratio per stage was ~10:1 for four stages giving a total solvent to pulp composition ratio of ~40:1. The leaching time per stage was approximately ~35 minutes per stage for a total time of ~140 minutes. The pulp composition before and after purification were analyzed for the classes of chemical contaminants typically present in recycled materials by GALAB Laboratories GmbH (Am Schleusengraben 7, 21029 Hamburg, Germany) using the methods disclosed in section IX Methods, as shown in Table #3. For the contaminants DEET, glyphosphate, isononylphenolmonoethoxylate, isononylphenoldiethoxylate, isononylphenoltriethoxylate, isononylphenoltetraethoxylate, bisphenol A, 1,2,3,4,6,7,8-HpCDD, OCDD, OCDF, PCB 81, PCB 105, PCB 118, di2-ehtylhexylphthalate, diisononylphthalate, fluoranthene, and phenanthrene, the % removal was 74.6%, >91.7%, >93.5%, >83.9%, >85.7%, >70.6%, >96.9%, 68.0%, 75.4%, 82.5%, 87.5%, 85.8%, 87.0%, 93.4%, 84.4%, >94.1%, and 86.9%, respectively, which was indicative of outstanding removal across a broad spectrum of chemical species and classifications.

The Pulp Composition before and after the purification was characterized for water retention value. The solvent leaching resulted in a 4.8% increase in the water-retention value which may be indicative of decreased hornification, which is opposite the trend observed with traditional water washing.

The Pulp Composition before and after the purification were processed into handsheets following Tappi T205 to produce a recycled paperboard and then evaluated for tensile properties and chemical composition. The solvent leaching resulted in an 11% reduction in tensile strength despite the decreased hornification. The solvent leaching process didn't remove significant ash but did significantly remove lignin at 10% removal from the pulp fibers, which is indicative of some lignin extraction possibly due to favorable partitioning between the solvent and the cellulose-based paper fibers.

TABLE 3
Purification of Reclaimed Post-Consumer Fiber #1 to Produce Post-Consumer Recycled Fiber
using Stirred Tank Reactor Flooded Leaching with Ethyl Acetate at Boiling Point

| | | Reclaimed Post-Consumer Pulp Composition | | |
|---|---|---|---|---|
| | | Before | After | |
| | | Purification | Purification | % |
| | LOQ | xLOQ | xLOQ | Removed |
| Pesticides | | | | |
| Diethyltoluamide (DEET) | 10 ppb | 28.0 | 7.1 | 74.6% |
| Glyphosate | 10 ppb | 12.0 | <1 | >91.7% |
| Alkylphenol ethoxylates | | | | |
| iso-Nonylphenolmonoethoxylate | 50 ppb | 4.0 | <1 | >93.5% |
| iso-Nonylphenoldiethoxytate | 50 ppb | 6.2 | <1 | >83.9% |
| iso-Nonylphenoltriethoxylate | 50 ppb | 7.0 | <1 | >85.7% |
| iso-Nonylphenoltetraethoxylate | 50 pob | 3.4 | <1 | >70.6% |
| Bisphenols | | | | |
| Bisphenol A | 5 ppb | 32.0 | <1 | >96.9% |
| Dioxins and dioxinlike and PCB | | | | |
| 1,2,3,4,6,7,8-HpCDD | 0.2 ppTr | 145.5 | 48.5 | 68.0% |
| OCDD | 0.2 ppTr | 1355.0 | 333.0 | 75.4% |
| OCDF | 0.2 ppTr | 43.8 | 7.7 | 82.5% |
| PCB 81 | 0.05 ppTr | 131.0 | 16.4 | 87.5% |
| PCB 105 | 5 ppTr | 73.2 | 10.4 | 85.8% |
| PCB 118 | 10 ppTr | 68.9 | 9.0 | 87.0% |
| Phthalates | | | | |
| Di-2-ethylhexyl phthalate | 50 ppb | 134.0 | 8.8 | 93.4% |
| Diisononyl phthalate | 50 ppb | 100.0 | 15.6 | 84.4% |
| Polycyclic aromatic hydrocarbons (PAH) | | | | |
| Fluoranthene | 1 ppb | 17.0 | <1 | >94.1% |
| Phenanthrene | 1 ppb | 13.0 | 1.7 | 86.9% |
| | | | | % Increase |
| Water Retention Value (g/g) | | 1.25 +/− 0.1 | 1.31 +/− 0.19 | 4.8% |
| FQA Fines Levet (%) | | 9.4 +/− 0.0 | 9.6 +/− 0.2 | 2.1% |
| Handsheet Tensile Strength (kN/m) | | 1.8 +/− 0.1 | 1.8 +/− 0.1 | −11.1% |
| Handsheet Zero Span Tensile Strength (kg [symbol] ) | | 8.41 +/− 0.32 | 8.16 +/− 0.40 | −3.1% |
| Compositional Information | wt % | | | % Removed |
| Ash(%) | | 6.2 | 6.8 | −9.7% |
| Klason Lignin (%) | | 14.2 +/− 0.1 | 12.8 +/− 0.1 | 9.9% |
| Acid soluble Lignin (%) | | 0.9 +/− 0.0 | 0.9 +/− 0.0 | 0.0% |
| % Lignin Level | | 15.2 +/− 0.1 | 13.7 +/− 0.1 | 9.9% |

[symbol]

indicates data missing or illegible when filed

### Inventive Example 2—Acetone Leaching of Reclaimed Post-Consumer Pulp Composition in Paperboard Form to Produce a Purified Post-Consumer Recycled Pulp Composition

2,500 grams of acetone was added to a 5 L stirred round bottom flask. The flask was outfitted with a mechanical stirrer, one reflux condenser, and one heat jacket. The mechanical stirring was set to 400 rpm. The heating jacket was controlled by a variable voltage transformer. The heat was applied to rapidly bring the acetone to boiling (~52 °C) in about 5 minutes. After reaching the boiling point of acetone, the heat input was lowered to achieve a consistent reflux rate of ~10 ml/min at the boiling point of ~52 °C. Contaminated pulp composition in the form of Reclaimed Post-Consumer Pulp Composition in paperboard form was cut into 1 cm×1 cm squares. The ~250 grams of the cut recycled Reclaimed Post-Consumer Fiber #1 was added to the round bottom flask which contained the boiling acetone. The extraction was continued for ~30 minutes. The stirring was terminated, and the heat was removed. The acetone was decanted from the mixture of solids and liquids. An additional 2,500 grams of preheated fresh acetone at or near the boiling point was added to the paperboard in the 5 L round bottom to complete a second extraction step. Stirring was started at 400 to 500 rpm while heating was applied sufficient to reflux the acetone at ~10 mL/min. The time to reach reflux after the addition of fresh acetone to the paperboard was ~5 minutes. The 2nd extraction continued for a total of ~30 minutes. The stirring was stopped, and the heat removed. The acetone was decanted off. An additional 2,500 grams of preheated fresh acetone at or near the boiling point was added to the paperboard in the 5 L round bottom to complete a third extraction step. Stirring was started at 400 to 500 rpm while heating was applied sufficient to reflux the acetone at ~10 mL/min. The time to reach reflux after the addition of fresh acetone to the paperboard was ~5 minutes. The 3rd extraction continued for a total of ~30 minutes. The stirring was stopped, and the heat removed. The acetone was decanted off. An additional 2,500 grams of preheated fresh acetone at or near the boiling point was added to the paperboard in the 5 L round bottom to complete a fourth extraction step. Stirring was started at 400 to 500 rpm while heating was applied sufficient to reflux the acetone at ~10 mL/min. The time to reach reflux after the addition of fresh acetone to the paperboard was ~5 minutes. The 4th extraction continued for a total of ~30 minutes. The stirring was stopped, and the heat removed. The acetone was decanted off. The paperboard contained a small amount of contaminated solvent residual within the porosity of the paperboard. This wet paperboard was placed in a filter flask w/o vacuum to further remove residual acetone. The paperboard was then completely dried of contaminated solvent at room temperature over-night to produce the Purified Pulp Composition or specifically Recycled Post-Consumer Pulp. The leaching solvent to pulp composition ratio per stage was ~10:1 for four stages giving a total solvent to pulp composition ratio of ~40:1. The leaching time per stage was approximately ~35 minutes per stage for a total time of ~140 minutes. The Pulp Composition before and after purification were analyzed for the classes of chemical contaminants typically present in recycled materials by GALAB Laboratories GmbH (Am Schleusengraben 7, 21029 Hamburg, Germany) using the methods disclosed in section IX Methods, as shown in Table #4. For the contaminants For the contaminants DEET, glyphosphate, isononylphenolmonoethoxylate, isononylphenoldiethoxylate, isononylphenoltriethoxylate, isononylphenoltetraethoxylate, bisphenol A, 1,2,3,4,6,7,8-HpCDD, OCDD, OCDF, PCB 81, PCB 105, PCB 118, di2-ehtylhexylphthalate, and diisononylphthalate, the % removal was 85.7%, >91.7%, >75.0%, >83.9%, >85.7%, >70.6%, >96.9%, 89.1%, 89.8%, 85.6%, >96.7%, 94.8%, 95.1%, 94.9%, and 12.0%, which was indicative of outstanding removal across a broad spectrum of chemical species and classifications.

The Pulp Composition before and after the purification was characterized for water retention value. The solvent leaching resulted in a 3.2% increase in the water-retention value which may be indicative of decreased hornification, which is opposite the trend observed with traditional water washing.

The Pulp Composition before and after the purification were processed into handsheets following Tappi T205 to produce a recycled paperboard and then evaluated for tensile properties and chemical composition. The solvent leaching resulted in a 17% increase in tensile strength possibly due to the decreased hornification. The solvent leaching process didn't remove significant ash but did significantly remove lignin at ~15% reduction from the pulp fibers, which is indicative of some lignin extraction possibly due to favorable partitioning between the solvent and the cellulose-based paper fibers.

TABLE 4
Purification of Method Using Current Invention involving Acetone Leaching of
Reclaimed Post-Consumer of Reclaimed Post-Consumer Pulp Composition in
Paperboard Form to Produce a Purified Post-Consumer Recycled Pulp Composition

| | | Reclaimed Post-Consumer Pulp Composition | | |
|---|---|---|---|---|
| | | Before | After | |
| | | Purification | Purification | % |
| | LOQ | xLOQ | xLOQ | Removed |
| Pesticides | | | | |
| Diethyltoluamide (DEET) | 10 ppb | 28.0 | 4.0 | 85.7% |
| Glyphosate | 10 ppb | 12.0 | <1 | >91.7% |
| Alkylphenol ethoxylates | | | | |
| iso-Nonylphenolmonoethoxylate | 50 ppb | 4.0 | <1 | >75.0% |
| iso-Nonylphenoldiethoxytate | 50 ppb | 6.2 | <1 | >83.9% |
| iso-Nonylphenoltriethoxylate | 50 ppb | 7.0 | <1 | >85.7% |
| iso-Nonylphenoltetraethoxylate | 50 pob | 3.4 | <1 | >70.6% |
| Bisphenols | | | | |
| Bisphenol A | 50 pob | 32.0 | <1 | >96.9% |
| Dioxins and dioxinlike and PCB | | | | |
| 1,2,3,4,6,7,8-HpCDD | 0.2 ppTr | 145.5 | 15.8 | 89.1% |
| OCDD | 0.2 ppTr | 1355.0 | 138.0 | 89.8% |
| OCDF | 0.2 ppTr | 43.8 | 6.3 | 85.6% |
| PCB 81 | 0.05 ppTr | 30.0 | <1 | >96.7% |
| PCB 105 | 5 ppTr | 73.2 | 3.8 | 94.8% |
| PCB 118 | 10 ppTr | 68.9 | 3.4 | 95.1% |
| Phthalates | | | | |
| Di-2-ethylhexyl phthalate | 50 ppb | 134.0 | 6.8 | 94.9% |
| Diisononyl phthalate | 50 ppb | 100.0 | 88.0 | 12.0% |
| Polycyclic aromatic hydrocarbons (PAH) | | | | |
| Fluoranthene | 1 ppb | 17.0 | dnt | n.a. |
| Phenanthrene | 1 ppb | 13.0 | dnt | n.a. |
| | | | | % Increase |
| Water Retention Value (g/g) | | 1.25 +/− 0.1 | 1.29 +/− 0.15 | 3.2% |
| FQA Fines Levet (%) | | 9.4 +/− 0.0 | 9.5 +/− 0.1 | 1.1% |
| Handsheet Tensile Strength (kN/m) | | 1.8 +/− 0.1 | 2.1 +/− 0.1 | 16.7% |
| Handsheet Zero Span Tensile Strength (kg [symbol] ) | | 8.41 +/− 0.32 | 9.31 +/− 0.44 | 10.7% |
| Compositional Information | wt % | | | % Removed |
| Ash(%) | | 6.2 | 6.1 | 1.6% |
| Klason Lignin (%) | | 14.2 +/− 0.1 | 12.0 +/− 0.1 | 15.5% |
| Acid soluble Lignin (%) | | 0.9 +/− 0.0 | 1.0 +/− 0.0 | −11.1% |
| % Lignin Level | | 15.2 +/− 0.1 | 12.8 +/− 0.1 | 15.1% |

[symbol]

indicates data missing or illegible when filed

### VIII. Packages

In some embodiments, recycled cellulosic pulp fiber and compositions described herein may be incorporated into packaging materials and packages.

Without wishing to be bound by theory, the inventors have unexpectedly found the recycled pulp fiber described herein may not only exhibit a lower level of trace chemicals, but also may exhibit improved levels of pulp performance as measured by the purer recycle pulp fiber properties of Water Retention Value, Fines Level (Lw), Handsheet Tensile Strength, Handsheet Zero Span Tensile, and combinations of these performance factors as well. The recycled pulp fiber described herein may be unexpectedly rejuvenated in these pulp performance factors as well as exhibiting low levels of trace chemicals. Inventive packages comprising the recycled pulp fiber described herein may not only exhibit lower levels of trace chemicals, but also may exhibit package and/or package material high performance levels of basis weight, recyclable percentage, seal tensile strength, MD tensile strength, CD tensile strength, burst strength, MD stretch at break, CD stretch at break, caliper, or combinations of these product characterizations.

Embodiments of the present invention may be packages comprising an amount of post-consumer recycled pulp fiber. Embodiments may include a package of one or more absorbent articles, the package comprising a package material, wherein the package material comprises from about 30 wt % to about 100 wt % post-consumer recycled pulp fiber. The packages may comprise a plurality of panels, wherein one of the panels is a consumer-facing panel; and/or wherein the package is sealed such that the one or more absorbent articles are enclosed therein.

In some embodiments, the package may comprise from about 30% to about 100%, from about 50% to about 100%, from about 75% to about 100%, from about 85% to about 100%, from about 90% to about 100%, from about 30% to about 50%, from about 30% to about 75%, from about 30% to about 90%, from about 50% to about 75%, from about 50% to about 90%, or from about 75% to about 90% post-consumer recycled pulp fiber. The remaining amount may be virgin natural fibers.

The package, or the package material, or the post-consumer recycled pulp fiber in the package material and the package, may also comprise a minimum number of contaminants and a maximum amount for any contaminant that is present.

In one embodiment, the package material comprises from about 85 wt % to about 100 wt % post-consumer recycled pulp fiber; and further comprises at least one of the following:
a. less than about 100 μg/kg of glyphosphate;
b. less than 150 μg/kg of isononylphenol(mono, di, tri, and tetra)exthoxylate;
c. less than 150 μg/kg of Bisphenol-A;
d. less than 25 ng/kg of 1,2,3,4,6,7,8-HpCDD;
e. less than 250 ng/kg of OCDD;
f. less than 5 ng/kg of OCDF;
g. less than 4 ng/kg of PCB 81;
h. less than 350 ng/kg of PCB 105;
i. less than 50 ng/kg of PCB 118;
j. less than 5,000 μg/kg of di-2ethylhexylphthalate;
k. less than 5,000 μg/kg of di-isononylphthalate;
l. less than 10 μg/kg of fluoranthene; and
m. less than 10 μg/kg of phenanthene;
as measured according to the Trace Chemicals Test Method.

In some embodiments, the package material may comprise recycled pulp fiber and comprises at least four, at least nine, or even all of (a) to (m) listed above.

In some embodiments, the pulp comprises a residual solvent content of less than less than 1,000 ppm, less than 500 ppm, less than 250 ppm, less than 150 ppm, less than 100 ppm, less than 50 ppm, less than 10 ppm, or less than 1 ppm, as measured according to the Trace Chemicals Test

### Method.

In some embodiments, the inventive package material may comprise a basis weight from 50 gsm to 120 gsm, and exhibit a recyclable percentage of between about 70 percent to about 99.9 percent as determined by the PTS-RH: 021/97 (Draft October 2019), under category II, test method.

In some embodiments, the package may comprise a plurality of seals, wherein each of the seals has a tensile strength of at least 3 N/in as determined via ASTM F88-06 as modified herein.

In some embodiments, at least one of the plurality of seals may have a higher tensile strength than another of the plurality of seals as determined via ASTM F88-06 as modified. In some embodiments, at least one of the plurality of seals may have a tensile strength of from 15N/in to about 40 N/in as determined via ASTM F88-06 as modified. In some embodiments, the tensile strength of at least one seal of the package may be from about 3 N/in to about 25 N/in, as determined via ASTM F88-06 as modified.

In some embodiments, at least one of the plurality of panels may comprise a background color, branding, and/or package information as determined via colorant detection method. In some embodiments, the at least one of the plurality of panels may comprise a percentage of colorant coverage of 75 percent or less. And in some embodiments, the consumer-facing panel may comprise a base color.

In some embodiments, the package may comprise one or more absorbent articles within the package, which may include, without being limited to, diapers, adult incontinence pants, menstrual pads, light adult incontinence pads, liners, and other similar personal care absorbent articles. The package may comprise other consumer products, including, without being limited to, sanitary tissues, sanitary tissue rolls, paper towels, kitchen towel rolls, facial tissue products, health care products, oral care products, skin care products, hair care products, laundry care products, or other types of consumer products. Furthermore, packages of the present disclosure may comprise or have contained therein, one or more moisture labile products, humidity labile products, moisture sensitive products, or water vapor sensitive products, including unit dose products, unit dose pouches, articles meant for single use, pouches, pouches with fibrous wall materials, pouches with soluble film wall materials, pouches comprising a single layer or ply, and combinations thereof. These unit dose or pouch form products may be delivery vehicles comprising active agents or additives designed and intended to provide a benefit to something, such as providing a benefit to an environment external to the unit dose or pouch. One embodiment may comprise a unit dose article or pouch where active agents are contained on the internal volume of the unit dose article or pouch. Another embodiment may comprise a unit dose or pouch comprising a single layer or ply where the active agent is contained within the single layer or ply, coated or embedded on the surface of the layer or ply, or a combination of these two configurations. Packages of the present invention may comprise a barrier layer or may not comprise a barrier layer. The packages of the present invention may or may not comprise a package material further comprising a barrier layer.

In some embodiments, the package may contain food stuff or eatable material. In some embodiments, the package material may have an inner surface, and the food stuff or eatable material may be in direct contact with the inner surface of the package material.

The package material of the present disclosure can be arranged as a package in a myriad of configurations. For example, the package may comprise a plurality of panels, including a consumer-facing panel. The consumer-facing panel is the face of the package, when on shelf, that faces the consumer. In general, the consumer-facing panel comprises branding and/or package information, each of which is described in additional detail herein. Also, each of the plurality of panels comprises an inner surface and an outer surface.

Packages of the present disclosure may comprise a generally cuboid shape. So, in addition to the consumer-facing panel, the packages of the present disclosure may further comprise a back panel opposing the consumer-facing panel, a left panel disposed between the consumer-facing panel and the back panel, a right panel opposing the left panel, a bottom panel disposed between the consumer-facing panel and the back panel, and an opposing top panel.

The package material may be unitary. For example, multiple folds may be utilized to form the plurality of panels of the package. To further elucidate the example where the package is a cuboid shape, at least one fold may be disposed between each of: (1) the consumer-facing panel and the left panel; (2) between the consumer-facing panel and the right panel; (3) between the consumer-facing panel and the top panel; and (4) between the consumer-facing panel and the bottom panel. Additionally, at least one fold may be disposed between each of: (1) the back panel and the left panel; (2) between the back panel and the right panel; (3) between the back panel and the top panel, and (4) between the back panel and the bottom panel.

As an alternative to the foregoing, the packages of the present disclosure may comprise package material which comprises a plurality of discrete portions. Such configurations are described in additional detail herein.

For packages which comprise a cuboid shape, the consumer-facing panel may be positioned generally perpendicular to a store shelf whereas the bottom panel may sit generally flat on the store shelf or atop another package. Generally perpendicular, assuming the store shelf to be perfectly horizontal, means that the consumer-facing panel is within plus or minus 35 degrees of a vertical orientation. Generally flat, again assuming the store shelf to be perfectly horizontal, means that the bottom panel is within plus or minus 35 degrees of a horizontal orientation. Alternatively, the consumer-facing panel, in some configurations, may be oriented generally horizontal to the store shelf and face the consumer as the consumer looks down on the package.

Other package shapes are contemplated. Examples of such packages include flow wrap or horizontal form-fill and seal wrap. Such packages may comprise a generally cuboid shape also configured as described above. However, in some instances, particularly where a low number of absorbent articles are included therein, these packages may comprise a consumer-facing panel and an opposing back panel. In such packages, a hoop seal may be formed, as described herein, as well as end seals. In such configurations, the consumer-facing panel may be oriented generally in a vertical direction or in a generally horizontal direction. Additionally, in such packages, there may be an absence of fold lines which distinguish the consumer-facing panel from the back panel. Instead, there may be a curved surface between these panels.

Additional examples are contemplated where package shapes comprising less than six panels are formed. Building on these examples, packages having a circular or semi-circular shape when viewed from a bottom panel are contemplated. Additionally, packages having a triangular shape when viewed from the bottom panel are contemplated. Regardless of the number of panels comprised by the packages of the present disclosure, the package comprises a consumer-facing panel.

In accommodating one or more absorbent articles or other consumer products, packaging material of the present disclosure, in addition to the natural fibers, may also comprise adhesives, coatings, colorants and/or other materials, e.g., barrier materials and/or barrier layers. The adhesives and/or the barrier material, e.g., film, may be utilized to create seals in the package material which seal the one or more absorbent articles therein. The creation of seals reduces the likelihood of contamination of the one or more absorbent articles within the package. And the coatings and/or colorants may be utilized to provide branding, background color, and/or package information on one or more of the panels. Unfortunately, the addition of adhesives, coatings, colorants and/or other materials, can be seen as non-recyclable materials in the recycling process. The use of adhesives, coatings, colorants and other materials, e.g., barrier materials, are discussed in additional detail hereafter.

It is worth noting that where a barrier material is utilized, the barrier material may be selected such that the use of adhesives can be reduced and possibly eliminated. One suitable example of a barrier material is a polyethylene film which may be coated on an inner surface of the package material. The polyethylene can be utilized to form the seals rather than an adhesive or possibly in conjunction with adhesive.

Additionally, the barrier material may at least partially inhibit the migration of water vapor through the package material. The barrier material may comprise a water soluble material that may not interfere with a recycling process. The barrier material may be easily separable from the remainder of the package materials through a recycling process, for example by having a different water solubility, density, or other physical features as compared to the remainder of the package materials.

However, forms are contemplated where the barrier material comprises a plastic film. In such instances, the weight percentage of the barrier material can impact the recyclability of the package material. For example, where the barrier material comprises a plastic film, the barrier material may be seen as non-recyclable material in the natural fiber recycling process. One example of a plastic film that can be utilized as a barrier material is polyethylene film. However, as noted previously, polyethylene film may obviate the need for adhesive for the creation of the seals of the packages of the present disclosure. Additionally, as the barrier material may not be recyclable in the same stream as the other package materials, the weight percentage of the barrier material may be in accordance with the present description regarding percentages of non-recyclable material discussed herein. It is worth noting though, that the barrier material may be recyclable via other recycling means, e.g., plastic film, plastic bag recycling.

There is currently no universal standard for determining whether a natural material is recyclable. In general, the higher the content of natural material, e.g., natural fibers, and the lower the content of non-recyclable material, the higher the likelihood of being recyclable. Some specific examples of standards which may be useful in determining whether package material is recyclable include the PTS method and Western Michigan method, and each is described below in additional detail. These methods pertain to the recyclability of materials which comprise wood fibers and/or pulp fibers.

Package materials of the present disclosure may comprise natural fibers, e.g., wood fibers and/or pulp fibers) which form a paper. The package material may comprise at least 50 percent by weight natural fibers, at least 70 percent by weight natural fibers, or at least 90 percent by weight natural fibers, specifically reciting all values within these ranges and any ranges created thereby. As yet another example, the package material may comprise 99.9 percent by weight natural fibers. The package materials of the present disclosure may comprise between 50 percent by weight to 100 percent by weight natural fibers, between 70 percent by weight to 99.9 percent by weight, or between 90 percent by weight to 99.9 percent by weight natural fibers. It is worth noting that where the weight percentage of natural fibers is less than 100 percent, the remaining weight percentage may be occupied by coatings, colorants, adhesives and/or other materials, e.g., barrier materials, if desired.

In order to increase the likelihood that the package material is recyclable, the total weight percentage of non-recyclable material, e.g., adhesives, films, coatings and/or colorants, in the package material of the present disclosure may be carefully selected. For example, the package material of the present disclosure may comprise 50 percent by weight or less, 30 percent by weight or less, or about 15 percent by weight or less of non-recyclable material, specifically including all values within these ranges and any ranges created thereby. As another example, the package materials of the present disclosure may comprise from between about 0.1 percent to about 50 percent by weight, from about 0.1 percent to about 30 percent by weight, or from about 0.1 percent to about 15 percent by weight of non-recyclable material, specifically including all values within these ranges and any ranges created thereby. If increased likelihood of recyclability is desired, the weight percentage of non-recyclable materials can be 5 percent by weight or less, or between 0.1 percent to 5 percent by weight, specifically reciting all values within these ranges and any ranges created thereby.

The effectiveness of the recycling process on the package material of the present disclosure may be determined via recyclable percentage. Package material of the present disclosure can exhibit recyclable percentages of 70 percent or greater, 80 percent or greater, or 90 percent or greater, specifically reciting all values within these ranges and any ranges created thereby. The packaging material of the present disclosure can have a recyclable percentage of between 70 percent to about 99.9 percent, from about 80 percent to about 99.9 percent, or from about 90 percent to about 99.9 percent, specifically reciting all values within these ranges and any ranges created thereby. In one specific example, the package material of the present disclosure may exhibit a recyclable percentage of from about 95 percent to about 99.9 percent, from about 97 percent to about 99.9 percent, or from about 98 percent to about 99.9 percent, specifically including all values within these ranges and any ranges created thereby. The recyclable percentage of the package material of the present disclosure can be determined via test PTS-RH: 021/97 (Draft October 2019) under category II, as performed by Papiertechnische Stiftung located at Pirnaer Strasse 37, 01809 Heidenau, Germany.

Along with recyclable percentage, the total reject percentage can be determined via the PTS-RH: 021/97 (Draft October 2019) under category II test method. However, unlike the recyclable percentage, in order to increase the likelihood of recyclability, the total reject percentage can be decreased. For example, the total reject percentage of the package material of the present disclosure can be 30 percent or less, about 20 percent or less, or less than about 10 percent or less, specifically including all values within these ranges and any ranges created thereby. For example, the total rejection percentage of the package material of the present disclosure can be from 0.1 percent to 30 percent, from 0.1 percent to 20 percent, or from 0.1 percent to 10 percent, specifically reciting all values within these ranges and any ranges created thereby. In one specific example, the total reject percentage can be less than 5 percent, or between 0.1 percent to 5 percent, 0.1 to 3 percent, or 0.1 to 2 percent, specifically including all values within these ranges and any ranges created thereby.

For the sake of clarity, the percent non-recyclable material does not necessarily have a 1:1 correlation to the total reject percentage. For example, the use of dissolvable adhesives is disclosed herein. As these adhesives are designed to dissolve during the recycling process, it is theorized that these adhesive would not have an impact on the total reject percentage; however, they would contribute to the non-recyclable material weight percent.

It is worth noting that the test method PTS-RH: 021/97 (Draft October 2019) under category II, comprises a handsheet inspection component. Trained screeners inspect one or more handsheets of recycled package material for visual imperfections and tackiness. If the number of visual imperfections is too great or if too tacky, then the package material is rejected. If the number of visual imperfections is acceptable and the handsheet is not too tacky, in accordance with the PTS-RH: 021/97 (Draft October 2019) method, then the package material is approved for additional processing. The package material of the present disclosure can yield an acceptable level of visual imperfections and tackiness during this step of the PTS method.

The package material of the present disclosure can yield the recyclable percentages mentioned heretofore as well as pass the handsheet screening method. So the package material of the present disclosure can achieve an overall score or final outcome of “pass” when subjected to the PTS-RH: 021/97 (Draft October 2019) under category II, recycling test method.

It is also worth noting that there is an alternative method for determining the recyclable percentage of the package material of the present disclosure. The test method performed by the University of Western Michigan called the Repulpability Test can provide a percent yield of recyclable material. The package material of the present disclosure can achieve a percentage yield, in accordance with the Repulpability Test, which is greater than about 70 percent, greater than about 80 percent, or greater than about 90 percent, specifically reciting all values within these ranges and any ranges created thereby. The packaging material of the present disclosure can have a percent yield of between 70 percent to about 99.9 percent, from about 80 percent to about 99.9 percent, or from about 90 percent to about 99.9 percent, specifically reciting all values within these ranges and any ranges created thereby. In one specific example, the package material of the present disclosure can exhibit a percentage yield of recyclable material which is between 80 percent and 99.9 percent, specifically including all values within this range and any ranges created thereby. In such example, the package material may comprise a base color of brown. In another specific example, the package material of the present disclosure can exhibit a percentage yield of recyclable material which is between 85 percent and 99.9 percent, specifically including all values within this range and any ranges created thereby. In such example, the package material may comprise a base color of white. Base colors of package materials are discussed in additional detail herein.

### Package Seals

As noted previously, packages of the present disclosure may also comprise a plurality of seals. Seals are package material seams which have been attached. Seams are areas of the package where at least two portions of the package material have the ability to overlap one another. Seals are created when the at least two portions of the package material in the seam are joined to one another, e.g., via adhesive. For example, a bottom panel may comprise seams where ends of the package material overlap. An adhesive may be provided on an interior surface of a first portion of the bottom panel and/or on an exterior surface of a second portion of the bottom panel as well as on an exterior surface of a base portion of the bottom panel to create one or more seals. The top panel may comprise seals where ends of the package material are joined together similar to the seals of the bottom panel. While the seals may be provided on any panel of the package, it is recommended that a consumer-facing panel not include seams or seals. Seams and seals can be visibly non-appealing for consumers.

It is worth noting that seams may comprise overlap areas of package material as described heretofore. Namely, adhesive may be applied on an inner surface of a first portion of the package material and/or an outer surface of a second portion of the package material. The first portion and the second portion can then be joined together to create an overlap seal. However, butt seals may also be created. Butt seals can be created where adhesive is applied to the inner surface of a first portion of the package material and/or the inner surface of a second portion of the package material. The inner surfaces of the first portion and the second portion may be joined to form a butt seal. Butt seals and overlap seals are discussed in additional detail hereafter.

The seals are important to ensure that the packages of the present disclosure reduce the likelihood of exposing the one or more absorbent articles therein to the environment outside of the package material. The use of seals, as described herein, can provide adequate sealing of the package material such that absorbent articles within the package are not exposed to the exterior environment. Simply folding or rolling of the package material does not form a seal as described herein.

In order to survive the rigors of the shipping, stocking, and handling by the consumer, the seals should have a requisite strength. Complicating the requirement for the requisite seal strength are a few variables, i.e., the type of seal and the level of compression of the one or more absorbent articles within the package. An additional complication is that adhesives are considered non-recyclable material. However, the inventors have surprisingly found that with careful selection of the type of adhesive and/or other sealing mechanism, e.g., polyethylene film, as well as the weight percentage, the seal strength requirements can be met along with maintaining the recyclability of the package material.

Regarding the types of seals, the plurality of seals of the packages of the present disclosure may comprise an access seal, a hoop seal, and a bottom seal. Flow wrap packages may be configured to comprise these seals as well. Or, the flow wrap packages may comprise a pair of opposing end seals and a hoop seal between the end seals. In this configuration, an access seal may similarly be provided.

The access seal may be provided as a seal which is opened by the consumer to access the one or more absorbent articles within the package. The hoop seal can be the initial seal created in the package making process. The bottom seal can be located on the bottom panel.

In general, the packages of the present disclosure may comprise seals which have a tensile strength of at least 3 N/in. For example, each of the plurality of seals of the packages of the present disclosure may have a tensile strength of between 3N/in to about 40 N/in, from about 3N/in to about 35 N/in, or from about 3N/in to about 30 N/in, specifically reciting all values included within these ranges and any ranges created thereby. For packages comprising absorbent articles which do not comprise a large amount of compression, e.g., menstrual pads, light adult incontinence pads, liners, packages with 6 or less absorbent articles therein, and the like, the tensile strength of the seals of this package may be from about 3 N/in to about 25 N/in, from about 3 N/in to about 20 N/in, or from about 3 N/in to about 15 N/in, specifically reciting all values within these ranges and any ranges created thereby.

For packages comprising compressed absorbent articles, the hoop seal may comprise a higher tensile strength than at least one of the other seals. For example, the hoop seal may comprise a tensile strength of between 15N/in to about 40 N/in, from about 20 N/in to about 35 N/in or from about 22 N/in to about 30 N/in, specifically reciting all values within these ranges and any ranges created thereby. In such packages, the one or more absorbent articles may comprise diapers or adult incontinence pants or moderate to heavy use adult incontinence pads. Additional examples are contemplated wherein at least one seal comprises a higher tensile strength than another seal. For example, the bottom seal may comprise a higher tensile strength than the hoop seal and/or the access seal. In another example, the access seal may comprise a high tensile strength than the hoop seal, bottom seal, or end seals. In yet another example, at least one end seal may comprise a higher tensile strength than the other end seal and/or the hoop seal.

Additionally, the inventors have surprisingly found that the access seal, can have a lower tensile strength than the hoop seal, and/or any other seal. In forms where the access seal is located on the top panel of the package, there is generally not as much load as on the hoop seal and other seal(s), e.g., bottom seal, end seal. It is worth noting that the access seal may be disposed on one or more of the top panel, right panel, and/or left panel. Or for flow wrap packages which comprise end seals and a hoop seal, one of the end seals can act as the access seal.

Alternatively, packages of the present disclosure may be configured such that the seals comprise similar tensile strengths. For example, each of the plurality of seals can have a tensile strength of at least 10N/in. In such forms, each of the seals can have a tensile strength which is within 15% of the tensile strength of the remainder of the seals of the package. However, as noted previously, since adhesives and/or other sealing mechanisms, e.g., polyethylene film, are considered non-recyclable material, their use should be carefully reviewed to ensure that the package material maintains its ability to be recycled. The tensile strengths of the seals mentioned herein can be determined by the tensile test method described in ASTM F88-06 as modified herein.

As was noted previously, the type as well as amount of adhesive utilized for the seals of the packages of the present disclosure can impact the recyclability of the package. As an example, adhesives which can dissolve in water during the re-pulping stage of the disintegration step of the recycling process may be particularly suitable for the packages of the present disclosure. Such adhesives include starch-based adhesives, polyvinyl alcohol based adhesives, and polyethylene oxide based adhesives. One suitable example of a starch-based adhesive is available from LD Davis, located in Monroe, North Carolina, under the trade name AP0420CR. One suitable example, of a polyvinyl alcohol based adhesive is available from Sekisui Chemical Company, located in Osaka, Japan, under the trade name Selvol 205. One suitable example of a polyethylene oxide based adhesive is available from Dow Chemicals Co., located in Midland, Michigan, under the trade name WSR N-80.

If the adhesive is not water-soluble, then water-dispersible adhesives may similarly be utilized. Suitable examples of water dispersible adhesives include thermoplastic elastomer based adhesives and polyvinyl acetate based adhesives. One suitable example of a thermoplastic elastomer based adhesive is available from Actega, located in Blue Ash, Ohio, under the trade name Yunico 491. One suitable example of a polyvinyl acetate based adhesive is available from Bostik, located in Milwaukee, Wisconsin, under the trade name Aquagrip 4419U01. Another suitable example of a polyvinyl acetate based adhesive is available from HB Fuller under the trade name PD-0330.

Any suitable pressure sensitive adhesives may be utilized as well. One suitable example of a pressure sensitive adhesives includes sold by Formulated Polymer Products Ltd., located in Bury, Lancashire, England, and sold under the trade name FP2154. As one specific example, the access seal may comprise a pressure sensitive adhesive.

As noted previously, the packages of the present disclosure may utilize a dissolvable adhesive, dispersible adhesive, pressure sensitive adhesive, or any combination thereof. However, the choice of adhesives should be considered carefully from a weight percentage standpoint. Where dissolvable adhesives are utilized, the adhesive may comprise at least one of the following: starch based, polyethylene oxide based, polyvinyl alcohol based, or combinations thereof.

Where dispersible adhesives are desired, much like the foregoing, care should be taken to ensure that the packaging material maintains its ability to be recycled. Where an adhesive, such as a polyvinyl acetate based adhesive is desired, the weight percentage can be about 12 percent by weight or less, about 10 percent by weight or less, specifically reciting all values within these ranges and any ranges created thereby. For example, polyvinyl acetate based adhesives can be utilized in an amount of from between about 0.5 percent by weight to about 12 percent by weight, from about 0.5 percent by weight to about 10 percent by weight, or 0.5 percent by weight to about 7 percent by weight, specifically reciting all values within these ranges and any ranges created thereby.

However, it is worth noting that where the dispersible adhesive is a thermoplastic elastomer based adhesive, different weight percentages may apply. For example, where the dispersible adhesive comprises a thermoplastic elastomer based adhesive, the weight percentage may be about 7 percent by weight or less, about 5 percent by weight or less, or about 4 percent by weight or less, specifically reciting all values within these ranges and any ranges created thereby. Further in this example, the weight percentage may be from between about 0.5 percent by weight to about 7 percent by weight, from about 0.5 percent by weight to about 5 percent by weight, or from about 0.5 percent by weight to about 4 percent by weight, specifically reciting all values within these ranges and any ranges created thereby.

Similar to the polyvinyl acetate adhesive, the foregoing weight percentages are believed to be applicable to achieve a total reject percentage of less than 5 percent as well as the handsheet inspection in accordance with the PTS method mentioned herein. It is believed that higher weight percentages of thermoplastic elastomer based adhesive may be utilized while still meeting the recyclability requirements of some jurisdictions, e.g., Western Michigan. For example, the weight percentage of thermoplastic elastomer based adhesives for the Western Michigan test are believed to be in the ranges of 0.5 to about 15 percent by weight, 0.5 to about 12 percent by weight, or from about 0.5 to about 7 percent by weight, specifically reciting all values within these ranges and any ranges created thereby.

The inventors have surprisingly found dispersible adhesives, such as thermoplastic elastomer and polyvinyl acetate based adhesives, can provide great seal strength while also being extremely flexible from an application standpoint. For example, where heat sealing is already utilized as part of an existing manufacturing line, these adhesives allow for the same flexibility, namely being heat sealable. As another example, these adhesives could be printed onto the packaging material which facilitates manufacturing. As another example, these adhesives can be applied via pattern coat or partial coat. Building on this example, these adhesives allow for the seal strength to be manipulated to a desired outcome. These adhesives may be applied in patterns, e.g., stripes, dots, etc. In this manner, these adhesives can provide the desired amount of seal strength in the desired location. Because of the flexibility in application of these adhesives to the package material of the present disclosure, seal strengths can be adjusted easily.

Regarding adhesive application, the inventors have surprisingly found that patterned application of adhesive can provide higher seal strength than full coat, i.e., solid coat, of adhesive. While solid coating of adhesive can still be utilized to achieve the seal strength values described herein, striped patterns may provide the same level of tensile strength while having the added advantage of using less adhesive. As an example, the inventors surprisingly found that adhesive applied in horizontal stripes (parallel or perpendicular to the longest dimension of the seal) as well as angled and cross hatch patterns, provided seal strengths similar to full coat applications while using less adhesive. So, packages of the present disclosure that comprise a discontinuous application of adhesive in at least one seal are contemplated.

It is worth noting that the characteristics of the seals of the packages of the present disclosure may depend on how the package material is processed. For example, an absorbent article manufacturer may purchase the package pre-formed. In such instances, the absorbent article manufacturer may receive from a paper package manufacturer essentially an open bag comprising a panel with a hoop seal and a panel with another seal, e.g., bottom seal. The other seal, e.g., bottom seal, may be configured in a block style, a cross style or pinch style arrangement. Such configurations are discussed in additional detail hereafter.

In creating an access seal, the absorbent article manufacturer may utilize the same adhesive utilized in the hoop seal and/or other seal, e.g., bottom seal. Alternatively, the absorbent article manufacturer may utilize an adhesive which is different than that of the hoop seal and/or the other seal, e.g., bottom seal.

It is also possible that the absorbent article manufacturer produces the packages themselves. For example, an absorbent article manufacturer may have the capability to produce the open bag, similar to above and subsequently fill it with one or more absorbent articles and thereafter seal it without the need for purchasing such bags from a supplier.

Another example where an absorbent article manufacturer produces the packages themselves include the flow wrap configuration. In such configuration, the manufacturer forms the package about the one or more absorbent articles as opposed to placing the one or more absorbent articles into a pre-formed bag. These types of packages of the present disclosure may comprise end seals and a hoop seal and may additionally comprise an access seal or one of the end seals may comprise the access seal.

Regardless of whether an absorbent article manufacturer purchases pre-made bags from a supplier or make the packages themselves, the foregoing seal configurations may still be provided. Namely, at least one seal may comprise a different adhesive than the other seals, or the adhesive in the seals may comprise the same adhesive.

Some contemplated examples include packages where the hoop seal and other seal, e.g., bottom seal, end seal(s), comprise a dissolvable adhesive and wherein the access seal or end seal comprises a dispersible adhesive. Another contemplated example is where the hoop seal and other seal, e.g., bottom seal, end seal(s), comprise a dissolvable adhesive and where the access seal or end seal comprises a pressure sensitive adhesive. Another contemplated example is where all of the seals comprise dispersible adhesives. Another example is where all of the seals comprise dissolvable adhesives. Still another example is where all of the seals comprise the same adhesive, e.g., a pressure sensitive adhesive, a dissolvable adhesive, or a dispersible adhesive. Still another example is where at least one of the plurality of seals comprises a pressure sensitive adhesive.

### Coatings and Colorants

Each of the plurality of panels comprises an inner surface and an outer surface. The outer surface and/or inner surface of one or more panels may comprise colorants and/or coatings, which create branding on the package, package information, and/or background color, etc. The branding and/or package information can be provided on an outer surface and/or inner surface of at least one panel, e.g., the consumer-facing panel. Branding can include logos, trade names, trademarks, icons, and the like, associated with the absorbent articles within the package. Branding can be utilized to inform a consumer of the brand of the absorbent articles within the package. As an example, branding for a package of feminine hygiene pads may comprise the brand name Always®.

Package information can include the size of the absorbent articles, the number of absorbent articles within the package, an exemplary image of the absorbent articles contained within the package, recyclability logos, and the like, associated with the absorbent articles within the package.

Additionally, package information can include information regarding the package material itself, e.g., recyclability logos, certifications from various organizations, or the like. As an example, package information for a package of feminine hygiene pads may comprise a size indicator, e.g., “Size 1.” Other panels of the package may similarly include branding, package information, and/or background color, along with that associated with the consumer-facing panel.

Additionally, one or more panels of the packages of the present disclosure may comprise colorants and/or coatings, to provide a background color to the packages of the present disclosure. To further clarify the background color, it is worth noting that the packaging material comprises a base color. A base color of the package material is the color of the package material without colorants and/or coatings. For example, bleached package material is white in color, unbleached is brown in color, and package material which includes recycled content can be grey in color. A background color is any color that is not a base color, e.g., blue, red, green, yellow, purple, orange, black, or combinations thereof. However, background color can also include white, brown, or grey, if the background color is achieved via colorants and/or coatings.

As noted previously, the use of colorants and/or coatings may be considered to be contaminants in the recyclability stream. So, the use of colorants and/or coatings should be carefully reviewed.

In such packages other panels may be configured having a higher percentage of colorant coverage, lower percentage, or a mix thereof. For example, in such configurations, a bottom panel may comprise a lower percentage of colorant coverage. A back panel, left panel, and/or right panel may comprise a higher percent colorant coverage percentage or a lower percentage of colorant coverage. These same values may apply for flow wrap configurations described herein as well. Colorant coverage percentage is determined via the Percentage of Colorant Coverage Measurement Method described herein.

While any suitable colorants may be utilized, the inventors have surprisingly found that water based colorants typically dissolve more readily in water during the recycling process. So, water based colorants can facilitate the recycling process for the packages of the present disclosure. Any suitable water based colorant may be utilized. Water based colorants are well known in the art.

It is worth noting that solvent based colorants and/or energy curable colorants may also be utilized. However, the use of these types of colorants can add complication to the manufacturing of the package material. For example, solvent based colorants generally exhaust volatile organic compounds which are required to be removed from the air. Additionally, solvent based colorants may comprise components which do not readily dissolve in water during the recycling process which could negatively impact the recyclability of the package material.

Any suitable coating utilized for packaging material may be utilized. Coatings can be utilized to protect the background color, branding, and/or package information. Additionally, coatings may be utilized to provide anti-static benefits, coefficient of friction benefits, and/or appearance benefits, e.g., gloss, matte, satin, high gloss, etc.) Much like water based colorants, the inventors have surprisingly found that water based coatings, if utilized, may facilitate the recycling process of the package material. Suitable coatings comprise varnishes which are well known in the art. Any suitable coating/varnish may be utilized.

In order to withstand the rigors of a manufacturing process where a plurality of absorbent articles is disposed within the package, withstand the rigors of being shipped, provide protection from environmental insults during shipping and while on the store shelf, and provide for product protection while in the consumers home, the package material may have some level of strength, stretch, and resilience. As an example, package material of the present disclosure may exhibit an MD tensile strength of at least 4.7 kN/m, at least 7 kN/m, or at least 8 kN/m, specifically reciting all values within these ranges and any ranges created thereby. The MD tensile strength may be between 4.7 kN/m to 8.5 kN/m, or between 5.2 kN/m and 8.2 kN/m, or between 5.5 kN/m and 8.0 kN/m, specifically reciting all values within these ranges and any ranges created thereby. The MD tensile strength is measured using ISO 1924-3 as modified herein.

As another example, the package material of the present disclosure can exhibit a CD tensile strength of at least 2.7 kN/m, at least 4 kN/m, or at least 5.5 kN/m, specifically reciting all values within these ranges and any ranges created thereby. The CD tensile strength may be between 2.7 to 6.5 kN/m, between 2.7 to 6.2 kN/m, or between 2.7 to 6 kN/m, specifically reciting all values within these ranges and any ranges created thereby. The CD tensile strength is measured using ISO 1924-3 as modified herein.

As another example, the package material of the present disclosure can exhibit a burst strength of at least 185 kPa, at least 250 kPa, or at least 550 kPa, specifically reciting all values within these ranges and any ranges created thereby. The burst strength of the package material of the present disclosure can be between 185 to 600 kPa, between 220 to 550 kPa, or between 250 to 500 kPa, specifically reciting all values within these ranges and any ranges created thereby. The burst strength is measured using ISO 2758 as modified herein.

As another example, the package material of the present disclosure may exhibit an MD stretch at break, at least 3 percent, or at least 6 percent, specifically reciting all values within these ranges and any ranges created thereby. The package material of the present disclosure can exhibit an MD stretch at break of between 3 to 6.5 percent, between 3.2 to 6.2 percent, or between 3.5 to 6 percent, specifically reciting all values within these ranges and any ranges created thereby. The MD stretch at break is measured using ISO 1924-3 as modified herein.

As another example, the package material of the present disclosure can exhibit a CD stretch at break of at least 4 percent, at least 6 percent, or at least 9 percent, specifically reciting all values within these ranges and any ranges created thereby. The package material of the present disclosure can exhibit a CD stretch at break of from 4 to 10 percent, from 4.5 to 9.5 percent, or from 5 to 9 percent, specifically reciting all values within these ranges and any ranges created thereby. The CD stretch at break is measured using ISO 1924-3 as modified herein.

As yet another example, the basis weight of the package material can affect the “feel” of the package to the consumer in addition to affecting the strength and resilience of the package material. Too low of a basis weight and the package can feel too flimsy. Too high and the package can feel too inflexible. The package material of the present disclosure can have a basis weight of between 50 to 120 gsm, between 60 to 105 gsm, or between 70 to 90 gsm, specifically reciting all values within these ranges and any ranges created thereby. The basis weight can be determined via ISO 536 as modified herein.

Regarding caliper, the package material of the present disclosure can exhibit caliper of at least 50 μm, at least 70 μm, or at least 90 μm, specifically reciting all values within these ranges and any ranges created thereby. The package material of the present disclosure can exhibit caliper of between 50 to 110 μm, from 55 to 105 μm, or from 60 to 100 μm, specifically reciting all values within these ranges and any ranges created thereby. The caliper is measured using ISO 534 as modified herein.

It is worth noting that the package material disclosed is different than cartonboard, cardboard, and brown paper bags. For example, cartonboard is not as flexible as the package materials of the present disclosure. Cartonboard is designed and is inherently stiffer than the package materials of the present disclosure and can be more difficult to process on converting lines due to their stiffness. But, the invention may comprise a cartonboard type package material as well. Additionally, cartonboard has a higher basis weight than do the package materials described in the present disclosure.

Similarly, cardboard is also different than the package materials described in the present disclosure. Cardboard has a much higher basis weight than the package materials of the present disclosure. Additionally, cardboard is much less flexible than the package materials of the present disclosure. Cardboard materials are commonly fluted and comprise three plies of a paper material and as such, is structurally different than the package materials of the present disclosure. Additionally, the package material of the present disclosure has a much lower basis weight than does cardboard. But, the invention may comprise a cardboard material as well.

In addition, examples are contemplated where the absorbent article backsheet is in direct contact with the inner surface of the package material. Packages of the present disclosure comprising diapers may be configured in this manner. Feminine hygiene pads, including menstrual pads, liners, adult incontinence pads, and the like, may be individually wrapped in order to protect panty fastening adhesive on their respective backsheets. In packages with these articles, the individually wrapped article may be in direct contact with the inner surface of the package material. Forms are contemplated where the wrapper which wraps the individual articles may comprise natural fibers as described herein. Additionally, such wrappers may be recyclable as described herein.

As noted previously, absorbent article manufacturers may purchase the packaging material already preformed into open bags or may purchase rolls of packaging material. Regardless of whether the package material is on rolls or pre-formed to some extent, the packages of the present disclosure begin with paper stock.

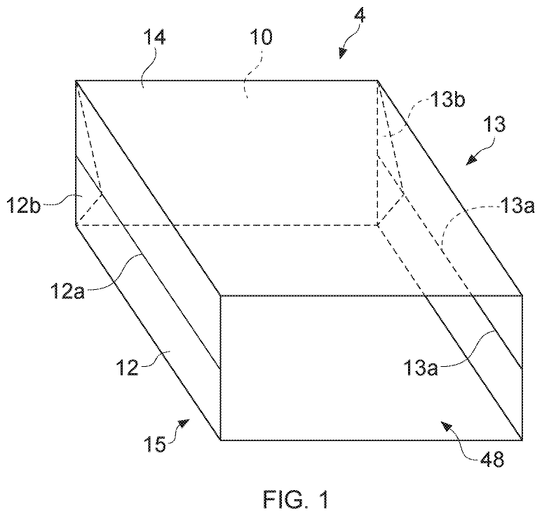

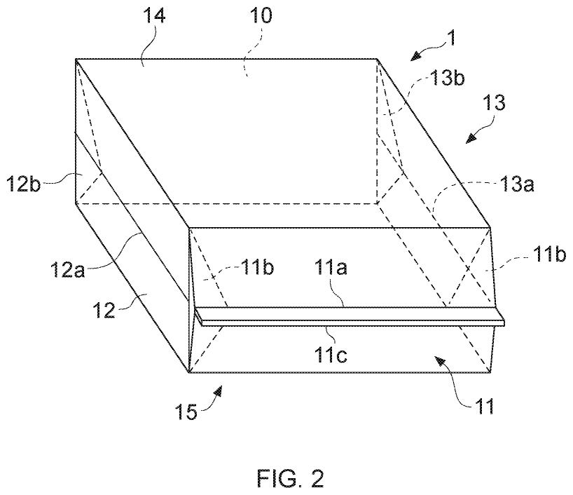

Referring now to FIGS. 1 and 2, the sheet of packaging material may be suitably folded to form bag side creases 12b and 13b and two side folds 12a and 13a on opposite sides, to form the bag structure 4 having a first surface 10, a second and third surface 12, 13, respectively, and a fourth and a fifth surface 14, 15. An open end 48 (e.g., a gusseted bag structure) opposes the first surface 10. Each side crease 12b, 13b is located at the respective second or third surface 12, 13. It is worth noting that in FIGS. 1 and 2, the crease and folds shown are for a package having a block configuration or block bottom configuration.

The bag 4 may be filled by inserting articles such as a stack of absorbent articles through the open end 48. When the bag 4 is filled with a plurality of articles, e.g., by entering articles from the open end 48, the device used to introduce the articles inside the bag 4 together with the articles may exert some tension on each of the second and third surfaces 12, 13 of the bag 4. For example, the articles can be compressed before being inserted into the bag 4. So the articles may slightly expand after they are introduced in the bag 4 and thus exert some tension on the second and third surfaces 12, 13 as well as the fourth surface 14 and the fifth surface 15. The tension is exerted on each of the creases 12b, 13b at the respective second and third surfaces 12, 13, particularly along the first and second side folds 12a, 13a with which the package may maintain a substantially parallelepiped-shape.

As may be appreciated from FIG. 2, the open end 48 opposite first surface 10 may then be closed to form the sixth surface 11. Any suitable style of closing may be utilized. As an example, the sixth surface may comprise closing gussets 11b by bringing edges of the bag 4 together and bonding them together to form a closing seam 11a and a closing seam fin 11c extending from the closing seam 11a, and sixth surface 11. In yet another example, the sixth surface may comprise seams which are joined together in a block style configuration or cross style configuration discussed hereafter.

Regardless of the sealing configuration, i.e., block, cross, or pinch, these configurations are known in the art. It is worth noting that for less bulky items where standability of the package is desired, the block bottom or cross bottom, may be desirable. However, for bulky items the pinch style configuration bags may be beneficial as the bulky absorbent articles therein can form a steady base for the package to stand. Additionally, it is worth noting that block style and cross style configuration packages tend to be themselves more-bulky than their pinch style counterparts. For the purposes of packaging, unfilled packages can come in stacks to an absorbent article manufacturer. Typically, stacks of block style and cross style configuration packages will take up more space—due to their bulkiness—than their pinch style counterparts. The bulkiness of the block and cross style configurations can make the stacks more difficult to manipulate during the filling process particularly where a large number of packages are created per minute. In such instances, the bulkiness of these configurations can mean an increased frequency of replenishment of the stacks. So for packages (unfilled) comprising the same packaging material but different sealing style, i.e., block and pinch, the block style configuration will take up more space than their pinch style counterparts.

Referring back to FIGS. 1 and 2, the bag 4 and package 1 dimensions may be suitably selected and effected through design, folding, stacking, compression and packaging processes so that the package 1 retains the absorbent articles therein and maintains a neat, stable, a substantially parallelepiped-shape, i.e., a cuboid shape of the package 1.

The first surface 10 may comprise the top panel of the package 1. Or the first surface 10 may comprise bottom panel of the package 1. It is worth noting that if the first surface 10 comprises seals, it may be desirable to make the first surface 10 comprise the bottom panel. In this way the seals may be hidden from view on the store shelf. Similarly, the second and third surfaces 12 and 13, as they may comprise gussets 12b and 13b, respectively, may comprise the left panel and right panel, respectively, or vice versa. Which leaves one of the fourth and fifth surfaces 14 and 15 to comprise the consumer-facing panel. So, at least one of the fourth and/or fifth surface 14, 15, may comprise branding, package information and/or background color as described herein. However, as noted previously, branding, package information, and/or background color is not limited to the consumer-facing panel. Any combination of the panels of the packages of the present disclosure may comprise branding, package information, and/or background color.

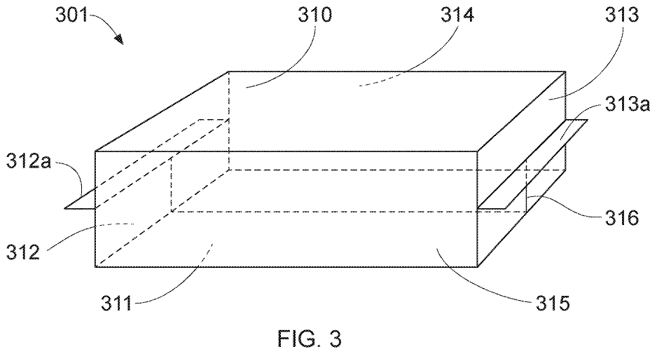

Recall that the flow wrap package configuration was also discussed heretofore. Some examples of flow wrap packages are shown in FIG. 3. FIG. 3 shows an exemplary flow wrap package which comprises a generally cuboid shape. Cuboid-shaped packages were discussed heretofore. Package 301, as shown comprises a first panel 311, opposing second and third panels 312 and 313, respectively; opposing fourth and fifth panels 314 and 315, respectively, and a sixth panel 310 opposing the first panel 311. As shown, the second panel 312 may comprise an end seal 312a, and the third panel 313 may comprise an end seam 313a. A hoop seal 316 may be disposed, in part on the second panel 312, the third panel 313, and the sixth panel 310. In such configurations, either the first panel 311 or the fifth panel 315 may comprise the consumer-facing panel.

It is worth noting that the absorbent articles within the packages of the present disclosure can be arranged in a myriad of configurations. For example, absorbent articles of the present disclosure may be disposed within the package such that they are oriented in a vertical orientation, or the absorbent articles may be arranged such that they are arranged in a horizontal configuration. Forms are contemplated where a combination of horizontal and vertically oriented articles are provided in the package.

Additionally, the articles within the package may be oriented such that one longitudinal peripheral edge of each of the plurality of articles is more proximal to the consumer-facing panel than another longitudinal peripheral edge. For example, where the number of absorbent articles within the package is relatively high, e.g., greater than nine, the absorbent articles may be arranged within the package as described heretofore. However, where the number of absorbent articles within the package is lower than, for example nine, the absorbent articles may be arranged such that a topsheet or a backsheet of an absorbent article is more proximal to the consumer-facing panel. Additional absorbent articles may be stacked behind the absorbent article which is closest to the consumer-facing panel. Forms are contemplated where there is a combination of orientations within the package. For example, at least one absorbent article can be arranged such that one of its longitudinal peripheral side edges is more proximal the consumer-facing panel than another, and at least one absorbent article can be arranged such that its topsheet or backsheet is more proximal to the consumer-facing panel. The remainder of the absorbent articles, if any, can assume either of those configurations.

Other non-limiting examples of packages and package materials suitable for use herein are described in U.S. Pat. No. 11,794,976, the descriptions of which are incorporated herein by reference.

### IX. Test Methods

### 1. Trace Chemicals Test Method

The content on a mass per mass basis of trace chemicals present in recycled pulp, tissue comprising recycle pulp, or packaging material comprising recycle pulp is determined using methods containing sample extraction and instrumental analysis approaches known of those of skill in the art and understood to be capable of extracting and detecting essentially all of a particular trace chemical in these materials. Suitable overall method specifics vary based on the particular trace chemical being quantified, though a common overall method structure is generally followed. A suitable method generally begins with increasing the surface area of a representative recycled pulp, tissue comprising recycle pulp, or packaging material comprising recycle pulp sample by cutting, shredding, and/or milling into small particles. An extraction step is then performed using a solvent capable of dissolving or diffusing into the sample and in which the trace chemical is readily soluble. The extraction process conditions (e.g., time and temperature) are optimized to maximize trace chemical recovery and common approaches include but are not limited to Soxhlet extraction, accelerated solvent extraction, and/or ultrasonic extraction. Internal standards (usually stable-isotope-labeled versions of the trace chemicals if mass spectrometry-based detection approaches are used) are added during the extraction step to account for potential losses during extraction and subsequent processing steps. After extraction is complete, the extraction solvent is isolated and worked up for instrumental analysis. Depending on the solvent used for extraction, the required quantitation limit, and the specific instrumental approach used, generation of a specimen suitable for instrumental analysis may require multiple cleanup and/or concentration steps including but not limited to centrifugation/filtration, liquid/liquid extraction, and/or column chromatography. The trace chemical in the worked-up specimen is then quantified using instrumental methods (e.g., GC-MS, GC-MS/MS, GC-HRMS, LC-MS/MS, etc.) known to those of skill in the art and specifically adapted to the trace chemical of interest. Suitable instrumental approaches may be developed de novo or may be based on standard, known methods for particular trace chemicals (e.g., US EPA Method 1613 in the case of dioxins and furans or US EPA 1668 for PCBs). Based on a combination of raw instrumental quantitative results, extraction solvent workup steps, original extraction volume, and starting specimen mass, the mass content of a trace chemical per mass of starting specimen material is calculated and is reported as the level of the trace chemical in the material tested. Given the generally low levels of trace chemicals present, common units used in reported levels of trace chemicals are μg/kg and ng/kg (equivalent to the ppb and ppt levels, respectively).

One of skill in the art will recognize that trace chemicals are often present at very low “trace” levels, meaning that under some circumstances, environmental and/or laboratory background levels of these same trace chemicals may give rise to false positive detects or falsely elevated results if appropriate precautions are not taken. While one of skill in the art recognizes that a suite of measures may be needed to minimize such false results, one obligatory measure is to include a true “blank” beginning with solvent carried in parallel through the extraction step, extraction solvent workup, and instrumental analysis.

Using the suitable overall methodology outlined above, one of skill in the art may quantify a range of trace chemicals potentially present in a recycled pulp, tissue comprising recycle pulp, or packaging material comprising recycle pulp sample of interest. For example, just to describe a few of the trace chemicals listed herein, the level of isononylphenol (CAS RN 11066-49-2) may be determined and reported as mass of trace chemical per mass of material in units of μg/kg. Similarly, the level of PCB 118 (CAS RN 31508-00-6) may be determined and reported in units of ng/kg, the level of OCDD (CAS RN 3268-87-9), a dioxin, may be determined and reported in units of ng/kg, the level of bisphenol A (CAS RN 80-05-7), also known as BPA, may be determined and reported in units of μg/kg, and the level of diisononyl phthalate (CAN RN 28553-12-0), also known as DINP, may be determined and reported in units of μg/kg.

### 2. Water Retention Value Test Method

The water retention value of pulp was measured according to Tappi UM 256.

### 3. % Fines Level (Fiber Quality Analysis Test Method)

The pulp morphology including fiber length, width, coarseness, fines was characterized optically according Tappi T271 om-23 using a Fiber Quality Analyzer (FQA-360).

4. Handsheet Tensile Properties Test Method Hand sheet was made according to Tappi T205 for paper mechanical properties test. The tensile properties of hand sheet were measured according to Tappi T494.

### 5. Handsheet Zero Span Tensile Test Method

The Zero-span breaking strength of pulp was measured according to Tappi T231.

### 6. % Lignin Level Test Method

The % lignin level in pulp was determined according to the standard protocol provided by the National Renewable Energy Laboratory. (J. Agric. Food Chem. 2010, 58, 16, 9043-9053).

### 7. Water Content Test Method

The water (moisture) content present in a fibrous structure is measured using the following Water Content Test Method.

A fibrous structure or portion thereof (“sample”) is placed in a conditioned room at a temperature of 73 °F±4 °F (about 23 °C±2.2 °C) and a relative humidity of 50%±10% for at least 24 hours prior to testing. The weight of the sample is recorded when no further weight change is detected for at least a 5 minute period. Record this weight as the “equilibrium weight” of the sample. Next, place the sample in a drying oven for 24 hours at 70 °C with a relative humidity of about 4% to dry the sample. After the 24 hours of drying, immediately weigh the sample. Record this weight as the “dry weight” of the sample. The water (moisture) content of the sample is calculated as follows:

$$\% Water ( moisture ) in sample = 100 \% \times \frac{( Equilibrium weight of sample - Dry weight of sample )}{Dry weight of sample}$$

The % Water (moisture) in sample for 3 replicates is averaged to give the reported % Water (moisture) in sample.

### 8. ASTM F88-06-Seal Tensile Strength

This test method determines the strength of a seal in flexible barrier materials by measuring the force required to separate a test strip of material containing the seal. Seal strength is measured in accordance with compendial method ASTM F0088-06 on a constant rate of extension tensile tester, with procedural specifics noted herein. A suitable instrument is the Instron Model 5965 using Bluehill Universal Software, both available from Instron Norwood, MA), or equivalent. All measurements are performed in a laboratory maintained at 23 °C±2 °C and 50%±2% relative humidity and test samples are conditioned in this environment for 2 hours prior to testing. The preparation of the test specimens and test procedure is described in the referenced ASTM method, with the following specific details. The test specimen is cut to a width of 1.0 inch, the grip separation rate is 300 mm/min, and the tail-holding method is unsupported. The maximum force encountered as the test specimen is stressed to failure is recorded as force per unit width to the nearest 0.1 N/in. The test is repeated for a total of five replicate test specimens. Calculate the arithmetic mean for maximum seal strength and report as Tensile Strength to the nearest 0.1 N/in.

### 9. ISO 1924-3-Tensile Properties (Tensile Strength, Stretch, Energy Absorption)

The tensile properties (tensile strength, stretch and energy absorption) of a test sample are calculated from measured force and elongation values obtained using a constant rate of elongation test until the sample breaks. The test is run in accordance with compendial method ISO 1924-3, with modifications noted herein. Measurements are made on a constant rate of extension tensile tester using a load cell for which the forces measured are within 1% to 99% of the limit of the cell. A suitable instrument is the MTS Alliance using Test Suite Software, available from MTS Systems Corp., Eden Prairie, MN, or equivalent. All measurements are performed in a laboratory maintained at 23 °C±2 °C and 50%±2% relative humidity and test samples are conditioned in this environment for at least 2 hours prior to testing.

Measurements are made on both MD (machine direction) and CD (cross direction) test samples taken from rolls or sheets of the raw material, or test samples obtained from a finished package. When excising the test sample from a finished package, use care to not impart any contamination or distortion to the sample during the process. The excised sample should be free from residual adhesive and taken from an area of the package that is free from any seams or folds. The test sample is cut to a width of 25.4 mm with a length that can accommodate a test span of 50.8 mm. The long side of the sample is parallel to the direction of interest (MD, CD). Normally in finished packages, the MD runs from the bottom to the top of the package, but this can be verified by determining the fiber orientation if in doubt. Ten replicate test samples should be prepared from the MID and ten additional replicates from the CD.

Program the tensile tester for a constant rate of extension uniaxial elongation to break as follows. Set the gauge length (test span) to 50.8 mm using a calibrated gauge block and zero the crosshead. Insert the test sample into the grips such that the long side is centered and parallel to the central pull axis of the tensile tester. Raise the crosshead at a rate of 25.4 mm/min until the test sample breaks, collecting force (N) and extension (mm) data at 100 Hz throughout the test. Construct a graph of force (N) versus extension (mm). Read the maximum force (N) from the graph and record as Peak Force to the nearest 0.1 N, noting MD or CD. Read the extension at the maximum force (N) from the graph and record as Elongation at Break to the nearest 0.01 mm, noting MD or CD. From the graph, determine the point (z) where the tangent to the curve, with a slope equal to the maximum slope of the curve, intersects the elongation axis. Now calculate the area under the force vs elongation curve from point z up to the point of maximum force and report to the nearest 0.1 mJ, noting MD or CD. [Refer to FIG. 2 in ISO 1924-3 for a depiction of a typical force vs elongation curve where point z is denoted.]

Calculate the arithmetic mean Peak Force for all MD replicates and then all CD replicates and record respectively as Mean MD Peak Force and Mean CD Peak Force to the nearest 0.1 N. Calculate the arithmetic mean Elongation at Break for all MD replicates and then all CD replicates and record respectively as Mean MD Elongation at Break and Mean CD Elongation at Break to the nearest 0.01 mm. Calculate the arithmetic mean area under the force vs elongation curve for all MD replicates and then all CD replicates and record respectively as Mean Area Under MD Curve and Mean Area Under CD Curve to the nearest 0.1 mJ.

Tensile strength is calculated by dividing the Mean Peak Force (N) by the width of the test sample (25.4 mm). Calculate the tensile strength for the MD replicates and then the CD replicates and report respectively as MD Tensile Strength and CD Tensile Strength to the nearest 0.1 kN/m.

Stretch at break is calculated by dividing the Mean Elongation at Break (mm) by the initial test length (test span) of 50.8 mm, and then multiplying by 100. Calculate the stretch at break for the MD replicates and then the CD replicates and report respectively as MD Stretch at Break and CD Stretch at Break to the nearest percent.

### 10. ISO 2758-Burst Strength

Burst strength is the maximum uniformly distributed pressure that a test sample can withstand. Burst strength is measured in accordance with compendial method ISO 2758 using a test apparatus as described within the method. A suitable instrument is the 13-60 Burst Tester for Paper and Foils available from Testing Machines, Inc (New Castle, DE), or equivalent. The instrument is calibrated and operated as per the manufacturer's instructions. All measurements are performed in a laboratory maintained at 23 °C.+/−2 °C and 50%+/−2% relative humidity, and test samples are conditioned in this environment for at least 2 hours prior to testing.

Measurements are made on test samples taken from rolls or sheets of the raw material, or test specimens obtained from a finished package. When excising a test sample from a finished package, use care to not impart any contamination or distortion to the test sample during the process. The test sample must be larger than the clamps used to hold the test sample in the instrument. The test sample should be taken from an area free of folds, wrinkles or seams.

Measure the burst strength (using a clamping pressure sufficient to prevent slippage during the test, and a pumping rate of 95±15 mL/min) for a total of 10 replicate test samples. For samples that are sided, the side of the test sample that is meant to face the inside of the package faces the pressure when placed into the clamps, and 10 replicates are tested in this orientation. For samples that are balanced (not sided), 5 replicates are tested with the inside of the package facing the pressure and 5 replicates are tested with the outside of the package facing the pressure, and the results are averaged together. Record the pressure at which each test sample bursts to the nearest 0.001 kPa. If the burst pressure is less than 70 kPa, multiple layers of the test material must be used. To obtain the burst strength, divide the burst pressure by the number of layers tested. Calculate the arithmetic mean burst pressure for all replicates and report as Burst Strength to the nearest 0.001 kPa.

### 11. ISO 534-Caliper

The caliper, or thickness, of a single-layer test sample is measured under a static load by a micrometer, in accordance with compendial method ISO 534, with modifications noted herein. All measurements are performed in a laboratory maintained at 23 °C±2 °C and 50%±2% relative humidity and test samples are conditioned in this environment for at least 2 hours prior to testing.

Caliper is measured with a micrometer equipped with a pressure foot capable of exerting a steady pressure of 70 kPa±0.05 kPa onto the test sample. The micrometer is a dead-weight type instrument with readings accurate to 0.1 micron. A suitable instrument is the TMI Digital Micrometer Model 49-56, available from Testing Machines Inc., New Castle, DE, or equivalent. The pressure foot is a flat ground circular movable face with a diameter that is smaller than the test specimen and capable of exerting the required pressure. A suitable pressure foot has a diameter of 16.0 mm. The test sample is supported by a horizontal flat reference platform that is larger than and parallel to the surface of the pressure foot. The system is calibrated and operated per the manufacturer's instructions.

Measurements are made on single-layer test samples taken from rolls or sheets of the raw material, or test samples obtained from a finished package. When excising the test sample from a finished package, use care to not impart any contamination or distortion to the sample during the process. The excised sample should be free from residual adhesive and taken from an area of the package that is free from any seams or folds. The test sample is ideally 200 mm² and must be larger than the pressure foot.

To measure caliper, first zero the micrometer against the horizontal flat reference platform. Place the test sample on the platform with the test location centered below the pressure foot. Gently lower the pressure foot with a descent rate of 3.0 mm per second until the full pressure is exerted onto the test sample. Wait 5 seconds and then record the caliper of the test sample to the nearest 0.1 micron. In like fashion, repeat for a total of ten replicate test samples. Calculate the arithmetic mean for all caliper measurements and report the value as Caliper to the nearest 0.1 micron.

### 12. ISO 536-Basis Weight

The basis weight of a test sample is the mass (in grams) per unit area (in square meters) of a single layer of material and is measured in accordance with compendial method ISO 536. The mass of the test sample is cut to a known area, and the mass of the sample is determined using an analytical balance accurate to 0.0001 grams. All measurements are performed in a laboratory maintained at 23 °C±2 °C and 50%±2% relative humidity and test samples are conditioned in this environment for at least 2 hours prior to testing.

Measurements are made on test samples taken from rolls or sheets of the raw material, or test samples obtained from a finished package. When excising the test sample from a finished package, use care to not impart any contamination or distortion to the sample during the process. The excised sample should be free from residual adhesive and taken from an area of the package that is free from any seams or folds. The test sample must be as large as possible so that any inherent material variability is accounted for.

Measure the dimensions of the single layer test sample using a calibrated steel metal ruler traceable to NIST, or equivalent. Calculate the Area of the test sample and record to the nearest 0.0001 square meter. Use an analytical balance to obtain the Mass of the test sample and record to the nearest 0.0001 gram. Calculate Basis Weight by dividing Mass (in grams) by Area (in square meters) and record to the nearest 0.01 grams per square meter (gsm). In like fashion, repeat for a total of ten replicate test samples. Calculate the arithmetic mean for Basis Weight and report to the nearest 0.01 grams/square meter.

### 13. Percentage of Colorant Coverage Measurement Method

The Percentage of Colorant Coverage measurement method measures the percent area of colorant coverage on a package panel. A flatbed scanner capable of scanning a minimum of 24 bit color at 800 dpi with manual control of color management (a suitable scanner is an Epson Perfection V750 Pro from Epson America Inc., Long Beach CA, or equivalent) is used to acquire images. The scanner is interfaced with a computer running color calibration software capable of calibrating the scanner against a color reflection IT8 target utilizing a corresponding reference file compliant with ANSI method IT8.7/2-1993 (suitable color calibration software is Monaco EZColor or il Studio available from X-Rite Grand Rapids, MI, or equivalent). The color calibration software constructs an International Color Consortium (ICC) color profile for the scanner, which is used to color correct an output image using an image acquisition program that supports application of ICC profiles. The color corrected image is then segmented via color thresholding using color analysis software (a suitable image color analysis software is MATLAB R2017b available from The Mathworks, Inc., Natick, MA).

The samples are conditioned at about 23 °C±2 °C and about 50%±2% relative humidity for 2 hours prior to testing.

The scanner is turned on 30 minutes prior to calibration and image acquisition. Deselect any automatic color correction or color management options that may be included in the scanner software. If the automatic color management cannot be disabled, the scanner is not appropriate for this application. The recommended procedures of the color calibration software are followed to create and export an ICC color profile for the scanner. The color calibration software compares an acquired IT8 target image to a corresponding reference file to create and export the ICC color profile for a scanner, which will be applied within the image analysis program to correct the color of subsequent output images.

A sample is obtained from a package or package materials with identified panels. A single panel is selected and cut along its perimeter to remove it for testing. Panels selected for testing should not contain tears or wrinkles.

The scanner lid is opened, and the sample carefully laid flat on the center of the scanner glass with the colored surface oriented toward the glass. A scan containing a panel region is acquired at 24 bit color with a resolution of 800 dpi (approximately 31.5 pixels per mm) in reflectance mode. The ICC color profile is assigned to the image producing a color corrected sRGB image. This calibrated image is saved in an uncompressed format to retain the calibrated R,G,B color values, such as a TIFF file, prior to analysis.

The calibrated image is opened in the color analysis software. The image is smoothed using a 2D Gaussian filter with a sigma of 3 to blur out any individual dots of colorant. Next, utilizing a color thresholding program, a color space to perform the color thresholding is selected, for example CIELAB with its three color values L*, a*,b*. Then a region of interest (ROI) boundary is manually drawn within a visibly discernable region of only the base color, without any colorants present, to identify its color space values. A panel with no visible base color region will be deemed to have 100% colorant coverage. The thresholding levels in all three channels of the selected color space are then manually adjusted to segment the regions of the panel that contain colorant coverage from those regions of the base color. The area of the panel containing colorant coverage is measured and the percentage of the area of the panel containing colorant coverage is calculated and recorded to the nearest whole percent.

In like manner, prepare, scan and analyze six replicate package panels. Calculate and report the arithmetic mean of the measured percent area of colorant coverage values to the nearest whole percent.

### X. Combinations

A. A package of one or more absorbent articles, the package comprising a package material, wherein the package material comprises from about 30 wt % to about 100 wt % post-consumer recycled pulp fiber;
   wherein the package comprises a plurality of panels, wherein one of the panels is a consumer-facing panel;
   wherein the package is sealed such that the one or more absorbent articles are enclosed therein; and:
   wherein the package material comprises at least one of the following:
      a. less than about 100 μg/kg of glyphosphate;
      b. less than 150 μg/kg of isononylphenol(mono, di, tri, and tetra)exthoxylate;
      c. less than 150 μg/kg of Bisphenol-A;
      d. less than 25 ng/kg of 1,2,3,4,6,7,8-HpCDD;
      e. less than 250 ng/kg of OCDD;
      f. less than 5 ng/kg of OCDF;
      g. less than 4 ng/kg of PCB 81;
      h. less than 350 ng/kg of PCB 105;
      i. less than 50 ng/kg of PCB 118;
      j. less than 5,000 μg/kg of di-2ethylhexylphthalate;
      k. less than 5,000 μg/kg of di-isononylphthalate;
      l. less than 10 μg/kg of fluoranthene; and
      m. less than 10 μg/kg of phenanthene;
      as measured according to the Trace Chemicals Test Method.
B. The package of paragraph A, wherein the package material comprises at least 4 of (a)-(m).
C. The package of paragraph A or B, wherein the package material comprises at least 9 of (a)-(m).
D. The package of any one of paragraphs A-C, wherein the package material comprises all of (a)-(m).
E. The package of any one of paragraphs A-D, wherein the package material comprises from about 50 wt % to about 100 wt % post-consumer recycled pulp fiber.
F. The package of any one of paragraphs A-E, wherein the package material comprises from about 75 wt % to about 100 wt % post-consumer recycled pulp fiber.
G. The package of any one of paragraphs A-F, wherein the package material comprises from about 90 wt % to about 100 wt % post-consumer recycled pulp fiber.
H. The package of any one of paragraphs A-G, wherein the package material has a basis weight from about 50 gsm to about 120 gsm.
I. The package of any one of paragraphs A-H, wherein the package material exhibits a recyclable percentage of between about 70 percent to about 99.9 percent as determined by the PTS-RH: 021/97 (Draft October 2019), under category II, test method.
J. The package of any one of paragraphs A-I, wherein the package material comprises a residual solvent content of less than 1,000 ppm, as measured according to the Trace Chemicals Test Method.
K. The package of any one of paragraphs A-J, wherein the package comprises a plurality of seals, wherein each of the seals has a tensile strength of at least 3 N/in as determined via ASTM F88-06 as modified herein.
L. The package of any one of paragraphs A-K, wherein at least one of the plurality of seals has a higher tensile strength than another of the plurality of seals as determined via ASTM F88-06 as modified.
M. The package of any one of paragraphs A-L, wherein at least one of the plurality of seals has a tensile strength of from between 15N/in to about 40 N/in as determined via ASTM F88-06 as modified.
N. The package of any one of paragraphs A-M, wherein the tensile strength of at least one seal of the package is from about 3 N/in to about 25 N/in, as determined via ASTM F88-06 as modified.
O. The package of any one of paragraphs A-N, wherein at least one of the plurality of panels comprises a background color, branding, and/or package information as determined via colorant detection method.
P. The package of any one of paragraphs A-O, wherein the at least one of the plurality of panels comprises a percentage of colorant coverage of 75 percent or less.
Q. The package of any one of paragraphs A-P, wherein the consumer-facing panel comprises a base color.
R. The package of any one of paragraphs A-Q, wherein the one or more absorbent articles within the package are selected from the group consisting of diapers, adult incontinence pants, menstrual pads, light adult incontinence pads, and liners.
S. The package of any one of paragraphs A-R, wherein the package comprises a barrier layer.
T. The package of any one of paragraphs A-S, wherein the package does not comprise a barrier layer.
U. A package according to any one of paragraphs A-T comprising a food stuff or eatable material instead of one or more absorbent articles, the package comprising a package material, wherein the package material comprises from about 30 wt % to about 100 wt % post-consumer recycled pulp fiber;
   wherein the package comprises a plurality of panels, wherein one of the panels is a consumer-facing panel;
   wherein the package is sealed such that the food stuff or eatable material is enclosed therein; and:
   wherein the package material comprises at least one of the following:
      a. less than about 100 μg/kg of glyphosphate;
      b. less than 150 μg/kg of isononylphenol(mono, di, tri, and tetra)exthoxylate;
      c. less than 150 μg/kg of Bisphenol-A;
      d. less than 25 ng/kg of 1,2,3,4,6,7,8-HpCDD;
      e. less than 250 ng/kg of OCDD;
      f. less than 5 ng/kg of OCDF;
      g. less than 4 ng/kg of PCB 81;
      h. less than 350 ng/kg of PCB 105;
      i. less than 50 ng/kg of PCB 118;
      j. less than 5,000 μg/kg of di-2ethylhexylphthalate;
      k. less than 5,000 μg/kg of di-isononylphthalate;
      l. less than 10 μg/kg of fluoranthene; and
      m. less than 10 μg/kg of phenanthene;
      as measured according to the Trace Chemicals Test Method.
V. The package of according to U, wherein the package material has an inner surface, and the food stuff or eatable material is in direct contact with the inner surface of the package material.
W. A package according to any one of paragraphs A-V comprising sanitary tissues, sanitary tissue rolls, paper towels, kitchen towel rolls, facial tissue products, health care products, oral care products, skin care products, hair care products, laundry care products, moisture labile products, humidity labile products, moisture sensitive products, water vapor sensitive products, unit dose products, or unit dose pouches instead of one or more absorbent articles, the package comprising a package material, wherein the package material comprises from about 30 wt % to about 100 wt % post-consumer recycled pulp fiber;
   wherein the package comprises a plurality of panels, wherein one of the panels is a consumer-facing panel;
   wherein the package is sealed such that the product is enclosed therein; and;
   wherein the package material comprises at least one of the following:
      a. less than about 100 μg/kg of glyphosphate;
      b. less than 150 μg/kg of isononylphenol(mono, di, tri, and tetra)exthoxylate;
      c. less than 150 μg/kg of Bisphenol-A;
      d. less than 25 ng/kg of 1,2,3,4,6,7,8-HpCDD;
      e. less than 250 ng/kg of OCDD;
      f. less than 5 ng/kg of OCDF;
      g. less than 4 ng/kg of PCB 81;
      h. less than 350 ng/kg of PCB 105;
      i. less than 50 ng/kg of PCB 118;
      j. less than 5,000 μg/kg of di-2ethylhexylphthalate;
      k. less than 5,000 μg/kg of di-isononylphthalate;
      l. less than 10 μg/kg of fluoranthene; and
      m. less than 10 μg/kg of phenanthene;
      as measured according to the Trace Chemicals Test Method.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

We claim:

1. A package of one or more absorbent articles, the package comprising a package material, wherein the package material comprises from about 30 wt % to about 100 wt % post-consumer recycled pulp fiber;
wherein the package comprises a plurality of panels, wherein one of the panels is a consumer-facing panel;
wherein the package is sealed such that the one or more absorbent articles are enclosed therein; and:
wherein the package material comprises at least one of the following:
a. less than about 100 μg/kg of glyphosphate;
b. less than 150 μg/kg of isononylphenol(mono, di, tri, and tetra)exthoxylate;
c. less than 150 μg/kg of Bisphenol-A;
d. less than 25 ng/kg of 1,2,3,4,6,7,8-HpCDD;
e. less than 250 ng/kg of OCDD;
f. less than 5 ng/kg of OCDF;
g. less than 4 ng/kg of PCB 81;
h. less than 350 ng/kg of PCB 105;
i. less than 50 ng/kg of PCB 118;
j. less than 5,000 μg/kg of di-2ethylhexylphthalate;
k. less than 5,000 μg/kg of di-isononylphthalate;
l. less than 10 μg/kg of fluoranthene; and
m. less than 10 μg/kg of phenanthene;
as measured according to the Trace Chemicals Test Method.

2. The package of claim 1, wherein the package material comprises at least 4 of (a)-(m).

3. The package of claim 1, wherein the package material comprises at least 9 of (a)-(m).

4. The package of claim 1, wherein the package material comprises all of (a)-(m).

5. The package of claim 1, wherein the package material comprises from about 50 wt % to about 100 wt % post-consumer recycled pulp fiber.

6. The package of claim 1, wherein the package material comprises from about 90 wt % to about 100 wt % post-consumer recycled pulp fiber.

7. The package of claim 1, wherein the package material has a basis weight from about 50 gsm to about 120 gsm.

8. The package of claim 1, wherein the package material exhibits a recyclable percentage of between about 70 percent to about 99.9 percent as determined by the PTS-RH: 021/97 (Draft October 2019), under category II, test method.

9. The package of claim 1, wherein the package material comprises a residual solvent content of less than 1,000 ppm, as measured according to the Trace Chemicals Test Method.

10. The package of claim 1, wherein the package comprises a plurality of seals, wherein each of the seals has a tensile strength of at least 3 N/in as determined via ASTM F88-06 as modified herein.

11. The package of claim 10, wherein at least one of the plurality of seals has a higher tensile strength than another of the plurality of seals as determined via ASTM F88-06 as modified.

12. The package of claim 10, wherein at least one of the plurality of seals has a tensile strength of from between 15N/in to about 40 N/in as determined via ASTM F88-06 as modified.

13. The package of claim 10, wherein the tensile strength of at least one seal of the package is from about 3 N/in to about 25 N/in, as determined via ASTM F88-06 as modified.

14. The package of claim 1, wherein at least one of the plurality of panels comprises a background color, branding, and/or package information as determined via colorant detection method.

15. The package of claim 14, wherein the at least one of the plurality of panels comprises a percentage of colorant coverage of 75 percent or less.

16. The package of claim 1, wherein the one or more absorbent articles within the package are selected from the group consisting of diapers, adult incontinence pants, menstrual pads, light adult incontinence pads, and liners.

17. The package of claim 1, wherein the package comprises a barrier layer.

18. The package of claim 1, wherein the package does not comprise a barrier layer.

19. A package comprising a food stuff or eatable material, the package comprising a package material, wherein the package material comprises from about 30 wt % to about 100 wt % post-consumer recycled pulp fiber;
wherein the package comprises a plurality of panels, wherein one of the panels is a consumer-facing panel;
wherein the package is sealed such that the food stuff or eatable material is enclosed therein; and;
wherein the package material comprises at least one of the following:
a. less than about 100 μg/kg of glyphosphate;
b. less than 150 μg/kg of isononylphenol(mono, di, tri, and tetra)exthoxylate;
c. less than 150 μg/kg of Bisphenol-A;
d. less than 25 ng/kg of 1,2,3,4,6,7,8-HpCDD;
e. less than 250 ng/kg of OCDD;
f. less than 5 ng/kg of OCDF;
g. less than 4 ng/kg of PCB 81;
h. less than 350 ng/kg of PCB 105;
i. less than 50 ng/kg of PCB 118;
j. less than 5,000 μg/kg of di-2ethylhexylphthalate;
k. less than 5,000 μg/kg of di-isononylphthalate;
l. less than 10 μg/kg of fluoranthene; and
m. less than 10 μg/kg of phenanthene;
as measured according to the Trace Chemicals Test Method.

20. The package of claim 19, wherein the package material has an inner surface, and the food stuff or eatable material is in direct contact with the inner surface of the package material.
